(19) United States
(12) Patent Application Publication
(10) Pub. No.: US 2025/0374174 A1
(43) Pub. Date: Dec. 4, 2025

(54) METHOD OF COMMUNICATION APPARATUS AND COMMUNICATION APPARATUS

(71) Applicant: NEC Corporation, Minato-ku, Tokyo (JP)

(72) Inventors: Kundan TIWARI, Tokyo (JP); Toshiyuki TAMURA, Tokyo (JP); lskren lANEY, Tokyo (JP)

(73) Assignee: NEC Corporation, Minato-ku, Tokyo (JP)

(21) Appl. No.: 18/869,859

(22) PCT Filed: Jun. 2, 2023
(86) PCT No.: PCT/JP2023/020723

§ 371 Date: Nov. 27, 2024

(30) Foreign Application Priority Data
Jun. 10, 2022 (IN) 202211033469

(51) Int. Cl. H04W 48/18; H04W 12/06; H04W 60/04; H04W 84/04

(52) U.S. Cl. CPC H04W 48/18; H04W 12/06; H04W 60/04; H04W 84/042

(57) ABSTRACT

The current 3GPP specification(s) does not provide solution for a problem such as an unauthorized use of network slice by the UE.

An aspect of this disclosure includes a method of a communication apparatus. The method includes changing status of Single Network Slice Selection Assistance Information (S-NSSAI) included in Allowed Network Slice Selection Assistance Information (NSSAI). The method includes sending Pending NSSAI including the S-NSSAI in a case of changing the status.

### TECHNICAL FIELD

The present disclosure relates to a method of a communication apparatus, and a communication apparatus.

### BACKGROUND ART

According to the 3GPP TS 23.501[2], when the Subscribed S-NSSAI(s) are updated (i.e., some existing S-NSSAIs are removed and/or some new S-NSSAIs are added) and one or more are applicable to the Serving PLMN the UE is registered in, or when the associated mapping is updated the AMF shall update the UE with the Configured NSSAI for the Serving PLMN and/or Allowed NSSAI and/or the associated mapping to HPLMN S-NSSAIs. According to the 3GPP TS 23.501[2], when there is the need to update the Allowed NSSAI, the AMF shall provide the UE with the new Allowed NSSAI and the associated mapping to HPLMN S-NSSAIs.

In addition, a Network Slice-Specific Authentication and Authorization (NSSAA) procedure was introduced in a 3GPP specification(s) Release 16.

According to the 3GPP TS 23.501[2], a serving PLMN shall perform the NSSAA for the S-NSSAIs of the HPLMN which are subject to it based on subscription information.

A mapping between an S-NSSAI in the VPLMN and a Subscribed S-NSSAI in HPLMN can be updated by the AMF according to the 3GPP TS 23.501[2].

### SUMMARY OF INVENTION

### Technical Problem

After the NSSAA procedure has been introduced in 3GPP Release 16, for example, there is a case where the AMF updates that the NSSAA is needed for an S-NSSAI after sending the S-NSSAI (or another S-NSSAI mapped to the S-NSSAI) in NSSAI (e.g. an Allowed NSSAI) to the UE.

In this case, as the S-NSSAI (or the another S-NSSAI) is stored in the UE (e.g., within the Allowed NSSAI), it seems that the UE can use such S-NSSAI without performing Network Slice-Specific Authentication and Authorization (NSSAA) procedure.

This may cause an unauthorized use of network slice by the UE.

The current 3GPP specification(s) does not provide solution for this problem.

### Solution to Problem

An aspect of this disclosure includes a method of a communication apparatus. The method includes changing status of Single Network Slice Selection Assistance Information (S-NSSAI) included in Allowed Network Slice Selection Assistance Information (NSSAI). The method includes sending Pending NSSAI including the S-NSSAI in a case of changing the status.

An aspect of this disclosure includes a method of a communication apparatus. The method includes receiving Allowed Network Slice Selection Assistance Information (NSSAI) including Single Network Slice Selection Assistance Information (S-NSSAI). The method includes receiving Pending NSSAI including the S-NSSAI in a case where status of the S-NSSAI is changed. The method includes updating the Allowed NSSAI and the Pending NSSAI.

An aspect of this disclosure includes a method of a communication apparatus. The method includes changing status of Single Network Slice Selection Assistance Information (S-NSSAI) included in Allowed Network Slice Selection Assistance Information (NSSAI). The method includes performing Network Slice-Specific Authentication and Authorization (NSSAA) procedure for the S-NSSAI in a case of changing the status. The method includes receiving a message related to the S-NSSAI. The method includes sending a cause value. The cause value indicates that the S-NSSAI is in Pending NSSAI.

An aspect of this disclosure includes a method of a communication apparatus. The method includes receiving Allowed Network Slice Selection Assistance Information (NSSAI) including Single Network Slice Selection Assistance Information (S-NSSAI). The method includes sending a message including the S-NSSAI. The method includes receiving a cause value. The cause value indicates that status indicating that the S-NSSAI is not subject to Network Slice-Specific Authentication and Authorization (NSSAA) procedure is changed to status indicating that the S-NSSAI is subject to the NSSAA procedure. The method includes suspending a process related to the S-NSSAI.

An aspect of this disclosure includes a communication apparatus. The communication apparatus includes means for changing status of Single Network Slice Selection Assistance Information (S-NSSAI) included in Allowed Network Slice Selection Assistance Information (NSSAI). The communication apparatus includes means for sending Pending NSSAI including the S-NSSAI in a case of changing the status.

An aspect of this disclosure includes a communication apparatus. The communication apparatus includes means for receiving Allowed Network Slice Selection Assistance Information (NSSAI) including Single Network Slice Selection Assistance Information (S-NSSAI). The communication apparatus includes means for receiving Pending NSSAI including the S-NSSAI in a case where status of the S-NSSAI is changed. The communication apparatus includes means for updating the Allowed NSSAI and the Pending NSSAI.

An aspect of this disclosure includes a communication apparatus. The communication apparatus includes means for changing status of Single Network Slice Selection Assistance Information (S-NSSAI) included in Allowed Network Slice Selection Assistance Information (NSSAI). The communication apparatus includes means for performing Network Slice-Specific Authentication and Authorization (NSSAA) procedure for the S-NSSAI in a case of changing the status. The communication apparatus includes means for receiving a message related to the S-NSSAI. The communication apparatus includes means for sending a cause value. The cause value indicates that the S-NSSAI is in Pending NSSAI.

An aspect of this disclosure includes a communication apparatus. The communication apparatus includes means for receiving Allowed Network Slice Selection Assistance Information (NSSAI) including Single Network Slice Selection Assistance Information (S-NSSAI). The communication apparatus includes means for sending a message including the S-NSSAI. The communication apparatus includes means for receiving a cause value. The cause value indicates that status indicating that the S-NSSAI is not subject to Network Slice-Specific Authentication and Authorization (NSSAA) procedure is changed to status indicating that the S-NSSAI is subject to the NSSAA procedure. The communication apparatus includes means for suspending a process related to the S-NSSAI.

### BRIEF DESCRIPTION OF DRAWINGS

FIG. 1 is a signaling diagram of a First example of a First Aspect.

FIG. 2 is a signaling diagram of a Second example of the First Aspect.

FIG. 3 is a diagram illustrating a system overview.

FIG. 4 is a block diagram illustrating a UE.

FIG. 5 is a block diagram illustrating an (R)AN node.

FIG. 6 is a diagram illustrating System overview of (R)AN node based on O-RAN architecture.

FIG. 7 is a block diagram illustrating an RU.

FIG. 8 is a block diagram illustrating a DU.

FIG. 9 is a block diagram illustrating a CU.

FIG. 10 is a block diagram illustrating an AMF.

FIG. 11 is a block diagram illustrating a PCF.

FIG. 12 is a block diagram illustrating an AUSF.

FIG. 13 is a block diagram illustrating a UDM.

FIG. 14 is a block diagram illustrating an NSSF.

FIG. 15 is a diagram illustrating registration with AMF re-allocation procedure.

### DESCRIPTION OF EMBODIMENTS

### Abbreviations

For the purposes of the present document, the abbreviations given in 3GPP TR 21.905 [1] and the following apply. An abbreviation defined in the present document takes precedence over the definition of the same abbreviation, if any, in
3GPP TR 21.905 [1].
4G-GUTI: 4G Globally Unique Temporary UE Identity
5GC: 5G Core Network
5GLAN: 5G Local Area Network
5GS: 5G System
5G-AN: 5G Access Network
5G-AN PDB: 5G Access Network Packet Delay Budget
5G-EIR: 5G-Equipment Identity Register
5G-GUTI: 5G Globally Unique Temporary Identifier
5G-BRG: 5G Broadband Residential Gateway
5G-CRG: 5G Cable Residential Gateway
5G GM: 5G Grand Master
5G-RG: 5G Residential Gateway
5G-S-TMSI: 5G S-Temporary Mobile Subscription Identifier
5G VN: 5G Virtual Network
5QI: 5G QOS Identifier
AF: Application Function
AMF: Access and Mobility Management Function
AMF-G: Geographically selected Access and Mobility Management Function
AMF-NG: Non-Geographically selected Access and Mobility Management
Function
ANDSF: Access Network Discovery and Selection Function
AS: Access Stratum
ATSSS: Access Traffic Steering, Switching, Splitting
ATSSS-LL: ATSSS Low-Layer
AUSF: Authentication Server Function
AUTN: Authentication token
BCCH: Broadcast Control Channel
BMCA: Best Master Clock Algorithm
BSF: Binding Support Function
CAG: Closed Access Group
CAPIF: Common API Framework for 3GPP northbound APIs
CHF: Charging Function
CN PDB: Core Network Packet Delay Budget
CP: Control Plane
DAPS: Dual Active Protocol Stacks
DL: Downlink
DN: Data Network
DNAI: DN Access Identifier
DNN: Data Network Name
DRX: Discontinuous Reception
DS-TT: Device-side TSN translator
ePDG: evolved Packet Data Gateway
EBI: EPS Bearer Identity
EPS: Evolved Packet System
EUI: Extended Unique Identifier
FAR: Forwarding Action Rule
FN-BRG: Fixed Network Broadband RG
FN-CRG: Fixed Network Cable RG
FN-RG: Fixed Network RG
FQDN: Fully Qualified Domain Name
GFBR Guaranteed Flow Bit Rate
GMLC: Gateway Mobile Location Centre
GPSI: Generic Public Subscription Identifier
GUAMI: Globally Unique AMF Identifier
GUTI: Globally Unique Temporary UE Identity
HPLMN: Home Public Land Mobile Network
HR: Home Routed (roaming)
IAB: Integrated access and backhaul
IMEI/TAC: IMEI Type Allocation Code
IPUPS: Inter PLMN UP Security
I-SMF: Intermediate SMF
I-UPF: Intermediate UPF
LADN: Local Area Data Network
LBO: Local Break Out (roaming)
LMF: Location Management Function
LoA: Level of Automation
LPP: LTE Positioning Protocol
LRF: Location Retrieval Function
MCC: Mobile country code
MCX: Mission Critical Service
MDBV: Maximum Data Burst Volume
MFBR: Maximum Flow Bit Rate
MICO: Mobile Initiated Connection Only
MITM: Man In the Middle
MNC: Mobile Network Code
MPS: Multimedia Priority Service
MPTCP: Multi-Path TCP Protocol
N3IWF: Non-3GPP InterWorking Function
N3GPP: Non-3GPP access
N5CW: Non-5G-Capable over WLAN
NAI: Network Access Identifier
NAS: Non-Access-Stratum
NEF: Network Exposure Function
NF: Network Function
NGAP: Next Generation Application Protocol
NID: Network identifier
NPN: Non-Public Network
NR: New Radio
NRF: Network Repository Function
NSI ID: Network Slice Instance Identifier
NSSAA: Network Slice-Specific Authentication and Authorization
NSSAAF: Network Slice-Specific Authentication and Authorization Function
NSSAI: Network Slice Selection Assistance Information
NSSF: Network Slice Selection Function
NSSP: Network Slice Selection Policy
NSSRG: Network Slice Simultaneous Registration Group
NW-TT: Network-side TSN translator
NWDAF: Network Data Analytics Function
PCF: Policy Control Function
PCO: Protocol Configuration Options
PDB: Packet Delay Budget
PDR: Packet Detection Rule
PDU: Protocol Data Unit
PEI: Permanent Equipment Identifier
PER: Packet Error Rate
PFD: Packet Flow Description
PLMN: Public Land Mobile Network
PNI-NPN: Public Network Integrated Non-Public Network
PPD: Paging Policy Differentiation
PPF: Paging Proceed Flag
PPI: Paging Policy Indicator
PSA: PDU Session Anchor
PTP: Precision Time Protocol
QFI: QoS Flow Identifier
QoE: Quality of Experience
RACS: Radio Capabilities Signalling optimisation
(R)AN: (Radio) Access Network
RAT: Radio Access Technology
RG: Residential Gateway
RIM: Remote Interference Management
RQA: Reflective QoS Attribute
RQI: Reflective QoS Indication
RSN: Redundancy Sequence Number
SA NR: Standalone New Radio
SBA: Service Based Architecture
SBI: Service Based Interface
SCP: Service Communication Proxy
SD: Slice Differentiator
SEAF: Security Anchor Functionality
SEPP: Security Edge Protection Proxy
SMF: Session Management Function
SMSF: Short Message Service Function
SN: Sequence Number
SN name: Serving Network Name.
SNPN: Stand-alone Non-Public Network
S-NSSAI: Single Network Slice Selection Assistance Information
SSC: Session and Service Continuity
SSCMSP: Session and Service Continuity Mode Selection Policy
SST: Slice/Service Type
SUCI: Subscription Concealed Identifier
SUPI: Subscription Permanent Identifier
SV: Software Version
TMSI: Temporary Mobile Subscriber Identity
TNAN: Trusted Non-3GPP Access Network
TNAP: Trusted Non-3GPP Access Point
TNGF: Trusted Non-3GPP Gateway Function
TNL: Transport Network Layer
TNLA: Transport Network Layer Association
TSC: Time Sensitive Communication
TSCAI: TSC Assistance Information
TSN: Time Sensitive Networking
TSN GM: TSN Grand Master
TSP: Traffic Steering Policy
TT: TSN Translator
TWIF: Trusted WLAN Interworking Function
UCMF: UE radio Capability Management Function
UDM: Unified Data Management
UDR: Unified Data Repository
UDSF: Unstructured Data Storage Function
UE: User Equipment
UL: Uplink
UL CL: Uplink Classifier
UPF: User Plane Function
UPSI: UE Policy Section Identifier
URLLC: Ultra Reliable Low Latency Communication
URRP-AMF: UE Reachability Request Parameter for AMF
URSP: UE Route Selection Policy
VID: VLAN Identifier
VLAN: Virtual Local Area Network
VPLMN: Visited Public Land Mobile Network
W-5GAN: Wireline 5G Access Network
W-5GBAN: Wireline BBF Access Network
W-5GCAN: Wireline 5G Cable Access Network
W-AGF: Wireline Access Gateway Function

### Definitions

For the purposes of the present document, the terms and definitions given in 3GPP TR 21.905 [1] and the following apply. A term defined in the present document takes precedence over the definition of the same term, if any, in 3GPP TR 21.905 [1].

### CITATION LIST

### Non Patent Literature

NPL 1: [1] 3GPP TR 21.905: “Vocabulary for 3GPP Specifications”. V17. 1.0 (2021-12)
NPL 2: [2] 3GPP TS 23.501: “System architecture for the 5G System (5GS)”. V17.4.0 (2022-03)
NPL 3: [3] 3GPP TS 23.502: “Procedures for the 5G System (5GS)”. V17.4.0 (2022-03)
NPL 4: [4] 3GPP TS 23.503: “Policy and charging control framework for the 5G System (5GS) Stage 2” V17.4.0 (2022-03)
NPL 5: [5] 3GPP TS 24.501: “Non-Access-Stratum (NAS) protocol for 5G System (5GS) Stage 3”. V17.6.1 (2022-03)

### General

Those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the Aspects of the present disclosure so as not to obscure the figures with details that will be readily apparent to those skilled in the art having the benefit of the description herein.

For the purpose of promoting an understanding of the principles of the disclosure, reference will now be made to the Aspect illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or entities or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an Aspect”, “in another Aspect” and similar language throughout this specification may, but not necessarily do, all refer to the same Aspect.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which may be defined to have the following meanings. The singular forms “a”, “an”, and “the” include plural references unless the context clearly dictates otherwise.

As used herein, information is associated with data and knowledge, as data is meaningful information and represents the values attributed to parameters. Further knowledge signifies understanding of an abstract or concrete concept. Note that this example system is simplified to facilitate description of the disclosed subject matter and is not intended to limit the scope of this disclosure. Other devices, systems, and configurations may be used to implement the Aspects disclosed herein in addition to, or instead of, a system, and all such Aspects are contemplated as within the scope of the present disclosure.

Each of Aspects and elements included in each Aspects described below may be implemented independently or in combination with any other. These Aspects include novel characteristics different from one another. Accordingly, these Aspects contribute to achieving objects or solving problems different from one another and contribute to obtaining advantages different from one another.

An example object of this disclosure is to provide a method and apparatus that can solve the above problem.

The following list explains intended interpretation of terms being used in this disclosure;
Subscribed S-NSSAI, Subscribed S-NSSAIs or Subscribed S-NSSAI(s); It can be equal to a list of S-NSSAI(s) in the Subscribed NSSAI or S-NSSAI(s) in the Subscribed NSSAI.
Allowed S-NSSAI, Allowed S-NSSAIs or Allowed S-NSSAI(s); It can be equal to a list of S-NSSAI(s) in the Allowed NSSAI or S-NSSAI(s) in the Allowed NSSAI.
Configured S-NSSAI, Configured S-NSSAIs or Configured S-NSSAI(s); It can be equal to a list of S-NSSAI(s) in the Configured NSSAI or S-NSSAI(s) in the Configured NSSAI.
Rejected S-NSSAI, Rejected S-NSSAIs or Rejected S-NSSAI(s); It can be equal to a list of S-NSSAI(s) in the Rejected NSSAI or S-NSSAI(s) in the Rejected NSSAI.
Pending S-NSSAI, Pending S-NSSAIs or Pending S-NSSAI(s); It can be equal to a list of S-NSSAI(s) in the Pending NSSAI or S-NSSAI(s) in the Pending NSSAI.

In Aspects below, the Configured NSSAI(s) refers to the Configured NSSAI(s) received from a current serving PLMN. The current serving PLMN may be a PLMN where the UE currently uses or accesses or a PLMN which serves the UE currently.

In Aspects below, the NSSAA may be expressed as NSSAA procedure.

A method of a communication apparatus according to example aspect of this disclosure includes changing status of Single Network Slice Selection Assistance Information (S-NSSAI) included in Allowed Network Slice Selection Assistance Information (NSSAI). The method includes sending Pending NSSAI including the S-NSSAI in a case of changing the status.

A method of a communication apparatus according to example aspect of this disclosure includes receiving Allowed Network Slice Selection Assistance Information (NSSAI) including Single Network Slice Selection Assistance Information (S-NSSAI). The method includes receiving Pending NSSAI including the S-NSSAI in a case where status of the S-NSSAI is changed. The method includes updating the Allowed NSSAI and the Pending NSSAI.

A method of a communication apparatus according to example aspect of this disclosure includes changing status of Single Network Slice Selection Assistance Information (S-NSSAI) included in Allowed Network Slice Selection Assistance Information (NSSAI). The method includes performing Network Slice-Specific Authentication and Authorization (NSSAA) procedure for the S-NSSAI in a case of changing the status. The method includes receiving a message related to the S-NSSAI. The method includes sending a cause value. The cause value indicates that the S-NSSAI is in Pending NSSAI.

A method of a communication apparatus according to example aspect of this disclosure includes receiving Allowed Network Slice Selection Assistance Information (NSSAI) including Single Network Slice Selection Assistance Information (S-NSSAI). The method includes sending a message including the S-NSSAI. The method includes receiving a cause value. The cause value indicates that status indicating that the S-NSSAI is not subject to Network Slice-Specific Authentication and Authorization (NSSAA) procedure is changed to status indicating that the S-NSSAI is subject to the NSSAA procedure. The method includes suspending a process related to the S-NSSAI.

A communication apparatus according to example aspect of this disclosure includes a memory, and at least one hardware processor coupled to the memory. The at least one hardware processor is configured to change status of Single Network Slice Selection Assistance Information (S-NSSAI) included in Allowed Network Slice Selection Assistance Information (NSSAI). The at least one hardware processor is configured to send Pending NSSAI including the S-NSSAI in a case of changing the status.

A communication apparatus according to example aspect of this disclosure includes a memory, and at least one hardware processor coupled to the memory. The at least one hardware processor is configured to receive Allowed Network Slice Selection Assistance Information (NSSAI) including Single Network Slice Selection Assistance Information (S-NSSAI). The at least one hardware processor is configured to receive Pending NSSAI including the S-NSSAI in a case where status of the S-NSSAI is changed. The at least one hardware processor is configured to update the Allowed NSSAI and the Pending NSSAI.

A communication apparatus according to example aspect of this disclosure includes a memory, and at least one hardware processor coupled to the memory. The at least one hardware processor is configured to change status of Single Network Slice Selection Assistance Information (S-NSSAI) included in Allowed Network Slice Selection Assistance Information (NSSAI). The at least one hardware processor is configured to perform Network Slice-Specific Authentication and Authorization (NSSAA) procedure for the S-NSSAI in a case of changing the status. The at least one hardware processor is configured to receive a message related to the S-NSSAI. The at least one hardware processor is configured to send a cause value. The cause value indicates that the S-NSSAI is in Pending NSSAI.

A communication apparatus according to example aspect of this disclosure includes a memory, and at least one hardware processor coupled to the memory. The at least one hardware processor is configured to receive Allowed Network Slice Selection Assistance Information (NSSAI) including Single Network Slice Selection Assistance Information (S-NSSAI). The at least one hardware processor is configured to send a message including the S-NSSAI. The at least one hardware processor is configured to receive a cause value. The cause value indicates that status indicating that the S-NSSAI is not subject to Network Slice-Specific Authentication and Authorization (NSSAA) procedure is changed to status indicating that the S-NSSAI is subject to the NSSAA procedure. The at least one hardware processor is configured to suspend a process related to the S-NSSAI.

### First Aspect

When the UE sends a Registration request message including S-NSSAI(s) in the Requested NSSAI that is subject to the NSSAA, the AMF sends a Registration accept message including them to the list of Pending NSSAI. After completion of the Registration procedure, the AMF initiates the NSSAA procedure for the S-NSSAI(s) in the Pending NSSAI. If the NSSAA procedure is successful, the AMF informs the UE that the S-NSSAI(s) in the Pending NSSAI are now usable and let the UE to remove that S-NSSAI(s) from the storage of the Pending NSSAI in the UE and put them to the storage of the Allowed NSSAI in the UE.

The NSSAA procedure enables to perform an authentication and authorization to specific to use of network slice with an AAA server located in an external network.

After the NSSAA procedure has been introduced in 3GPP Release 16, for example, there is a case where the AMF updates a mapping of an Allowed S-NSSAI from a Subscribed S-NSSAI that are not subject to the NSSAA, to a Subscribed S-NSSAI that are subject to the NSSAA.

In this case, the 3GPP specification is unclear how the new Subscribed S-NSSAI is to be authenticated and authorized to allow the UE to access the mapped S-NSSAI.

As the S-NSSAI mapped with new Subscribed S-NSSAI is stored in the UE within the Allowed NSSAI, it seems that the UE can use such S-NSSAI without performing Network Slice-Specific Authentication and Authorization (NSSAA) procedure.

This may cause an unauthorized use of network slice by the UE.

In addition, for example, there is a case where the AMF updates that the NSSAA is needed for an S-NSSAI after sending an Allowed NSSAI including the S-NSSAI (or another S-NSSAI mapped to the S-NSSAI) to the UE.

In this case, as the S-NSSAI (or the another S-NSSAI) is stored in the UE within the Allowed NSSAI, it seems that the UE can use such S-NSSAI without performing Network Slice-Specific Authentication and Authorization (NSSAA) procedure.

The current 3GPP specification(s) does not provide solution for this problem.

This may cause an unauthorized use of network slice by the UE.

When an AMF 70 updates the mapping of an Allowed S-NSSAI from a Subscribed S-NSSAI that is not a subject to the NSSAA, to a Subscribed S-NSSAI that is subject to the NSSAA, the AMF 70 informs this update to a UE 3.

In this case, the current 3GPP specification is unclear how new Subscribed S-NSSAI is to be authenticated and authorized in order to allow the UE 3 to register and to access service(s) on the mapped S-NSSAI.

As the S-NSSAI mapped with new Subscribed S-NSSAI is stored in the UE 3 within the Allowed NSSAI, it seems that the UE 3 can use such S-NSSAI without performing Network Slice-Specific Authentication and Authorization procedure.

This may cause an unauthorized use of network slice by the UE 3.

The First Aspect can solve at least one of problems including the problems mentioned above.

### First example of the First Aspect

The first example of the First Aspect discloses a method where the AMF 70 sends a UE Configuration Update Command message to the UE 3 including a Pending S-NSSAI in a case where the AMF 70 updates a mapping of an S-NSSAI in the Configured NSSAI and/or in the Allowed NSSAI to a Subscribed S-NSSAI that is subject to the NSSAA and no NSSAA procedure for that S-NSSAI has been taken place in the PLMN. “S-NSSAI(s) is subject to NSSAA” or similar expressions in this disclosure may mean “network slice(s) identified by S-NSSAI(s) is subject to NSSAA” in this disclosure. “S-NSSAI(s) is not subject to NSSAA” or similar expressions in this disclosure may mean “network slice(s) identified by S-NSSAI(s) is not subject to NSSAA” in this disclosure.

For example, a network slice mapping update in the AMF 70 may be triggered when the AMF 70 receives an Nudm_SDM_Notification message from a UDM 75 informing a subscriber data change with regard to the network slices. For example, a network slice mapping update in the AMF 70 may be triggered by local configuration in the AMF 70 or operator's policy.

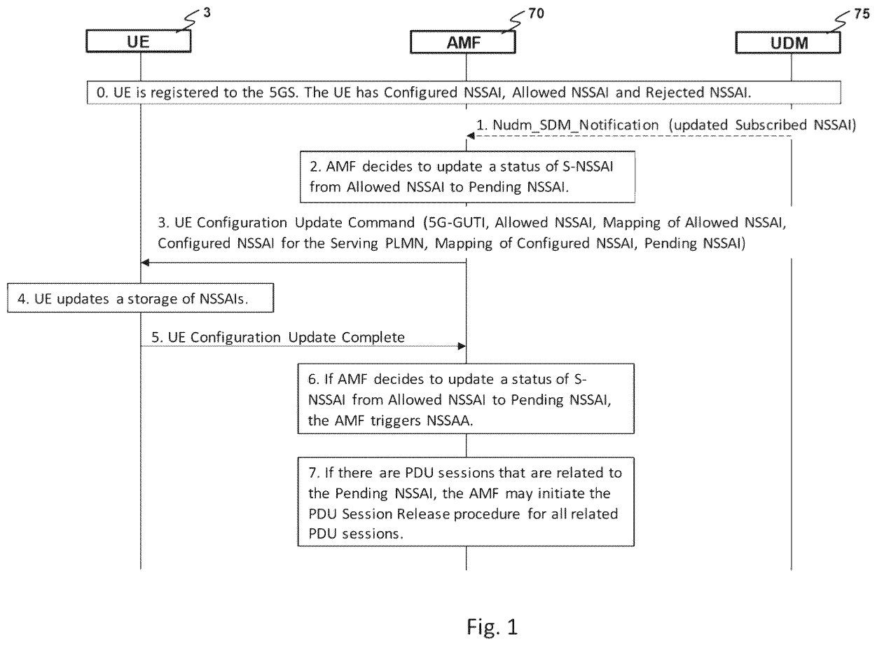

The detailed process of the First example of the First Aspect is described below, with reference to FIG. 1.

Step 0. The UE 3 is registered with a serving PLMN and a 5G-GUTI has been assigned by the AMF 70 to the UE 3. The UE 3 holds at least one of a Configured NSSAI and an Allowed NSSAI. The UE 3 may hold a Rejected NSSAI. The AMF 70 may hold the Configured NSSAI for the UE 3 and the Allowed NSSAI for the UE 3. The AMF 70 may hold the Rejected NSSAI for the UE 3. For example, at least one of S-NSSAIs in the Configured NSSAI is subject to the NSSAA while other S-NSSAI(s) in the Configured NSSAI is not subject to a NSSAA. For example, at least one of S-NSSAIs in the Allowed NSSAI is subject to a NSSAA while other S-NSSAI(s) in the Allowed NSSAI is not subject to a NSSAA. The UE 3 may receive at least one of the Allowed NSSAI, the Configured NSSAI and the Rejected NSSAI during registration procedure.

For example, the UE 3 may be an outbound roamer visiting a VPLMN. In this case, the AMF 70 maps a Subscribed S-NSSAI to an S-NSSAI of the VPLMN. The UE 3 may know the mapping of the Subscribed S-NSSAI to the S-NSSAI of the VPLMN (e.g. the UE 3 may receive information indicating the mapping from the AMF 70).

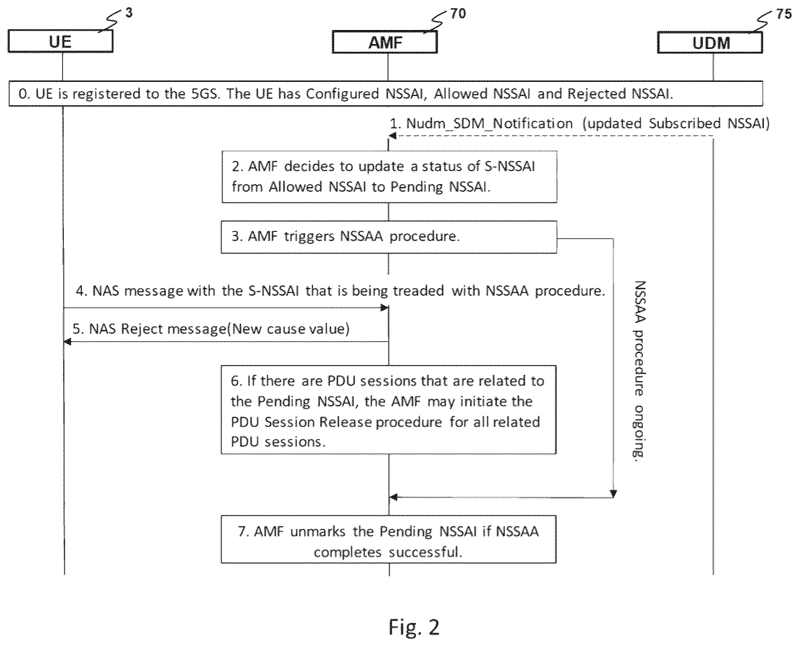

The step 0 may be same to step 0 in FIG. 2.

Step 1. The UDM 75 sends an Nudm_SDM_Notification massage to the AMF 70 including updated subscriber data with regard to the network slice(s) (e.g. the network slice mapping).

Note that the step 1 can be considered as a trigger to the AMF decision in step 2. For example, if the UDM 75 updates an attribution of NSSAA for the S-NSSAI(s) that is configured to the UE 3, from “NSSAA not required” to “NSSAA required”, this may be a trigger to the AMF decision in step 2.

The step 1 may be same to step 0 in FIG. 2.

The updated subscriber data may indicate the attribution of NSSAA for the S-NSSAI(s) that is configured to the UE 3. The attribution of NSSAA for the S-NSSAI(s) may indicate the attribution of the NSSAA for the S-NSSAI(s) changed from “NSSAA not required” to “NSSAA required”.

The updated subscriber data may indicate whether NSSAA is required regarding network slice(s) or S-NSSAI(s).

Step 2. The AMF 70 decides to update the status of an S-NSSAI from an Allowed NSSAI to a Pending NSSAI.

For example, in a case where the AMF 70 decides to update the status of an S-NSSAI from an Allowed NSSAI to a Pending NSSAI, the AMF 70 may remove the S-NSSAI from the Allowed NSSAI of the AMF 70 and may store the S-NSSAI in the Pending NSSAI of the AMF 70.

For example, the AMF 70 may decide to update the status of an S-NSSAI from an Allowed NSSAI to a Pending NSSAI in a case where the AMF 70 receives the Nudm_SDM_Notification massage.

For example, the AMF 70 may decide to update the status of an S-NSSAI from an Allowed NSSAI to a Pending NSSAI based on local configuration in the AMF 70 or operator's policy.

For example, the AMF 70 updates the mapping between the assigned S-NSSAI (e.g., S-NSSAI(s) in the Allowed NSSAI or S-NSSAI(s) in the Subscribed NSSAI or S-NSSAI(s) in the Configured NSSAI) and the Subscribed S-NSSAI based on local configuration update, and the newly mapped Subscribed S-NSSAI is subject to the NSSAA.

In another example, the AMF 70 updates a mapping between the assigned S-NSSAI and the Subscribed S-NSSAI based on local configuration update and the newly mapped Subscribed S-NSSAI is subject to the NSSAA, and the newly mapped Subscribed S-NSSAI has never been authenticated and authorized for NSSAA in the PLMN.

In another example, the AMF 70 receives the Nudm_SDM_Notification massage from the UDM 75 including updated subscriber data for the mapped Subscribed S-NSSAI where an attribute of NSSAA for the mapped Subscribed S-NSSAI is changed from “NSSAA not required” to “NSSAA required”.

For example, step 2 is also triggered if the serving PLMN (e.g. the AMF 70 currently serving the UE 3) changes the mapping between a VPLMN network slice which is in the Allowed NSSAI and a HPLMN network slice. For example, the AMF 70 changes a mapping such as VPLMN S-NSSAI A in the Allowed NSSAI (e.g. S-NSSAI A of the Allowed NSSAI in the VPLMN) and HPLMN S-NSSAI 1 (e.g. S-NSSAI 1 in the HPLMN) to a mapping such as VPLMN S-NSSAI A and

HPLMN S-NSSAI 2 (e.g. S-NSSAI 2 in the HPLMN). In a case where S-NSSAI 2 is subject to the NSSAA, the NSSAA procedure has not been executed for S-NSSAI 2 before i.e., the NSSAA status for S-NSSAI 2 is not there in the AMF 70. Then the AMF 70 may decide to update the status of S-NSSAI A from an Allowed NSSAI to a Pending NSSAI. In addition, for example, the AMF 70 may determine to include S-NSSAI A in not the Allowed NSSAI but the Pending NSSAI. The AMF 70 can know which network slice is subject to the NSSAA. For example, the AMF 70 may know which network slice is subject to the NSSAA based on local configuration in the AMF 70 or operator's policy. For example, the AMF 70 may know which network slice is subject to the NSSAA based on information received from the UDM 75. S-NSSAI I may not be subject to the NSSAA.

For example, the AMF 70 sends, to the UE 3, the Allowed NSSAI including S-NSSAI A of VPLMN which is mapped to S-NSSAI 1 of HPLMN. The UE 3 holds the Allowed NSSAI including S-NSSAI A. S-NSSAI 1 is not subject to the NSSAA. After sending the Allowed NSSAI, the AMF 70 changes the mapping such as S-NSSAI A and S-NSSAI 1 to a mapping such as S-NSSAI A and S-NSSAI 2 of the HPLMN. In this case, the NSSAA has not been executed for S-NSSAI 2 (or S-NSSAI A) before i.e., the NSSAA status for S-NSSAI 2 (or for S-NSSAI A) is not there in the AMF 70. Then the AMF 70 may decide to update the status of S-NSSAI A (or S-NSSAI 2) from the Allowed NSSAI to a Pending NSSAI. For example, the AMF 70 may determine to include S-NSSAI A (or S-NSSAI 2) in not the Allowed NSSAI but the Pending NSSAI.

For example, step 2 may be also triggered if the serving PLMN (e.g. the AMF 70 currently serving the UE 3) changes whether the NSSAA is needed for S-NSSAI(s). For example, the AMF 70 sends, to the UE 3, the Allowed NSSAI including S-NSSAI 1 which is not subject to the NSSAA. The UE 3 holds the Allowed NSSAI including S-NSSAI 1 which is not subject to the NSSAA. After sending the Allowed NSSAI, the AMF 70 changes an attribute of S-NSSAI 1 such that S-NSSAI 1 is subject to the NSSAA. In this case, the NSSAA procedure has not been executed for S-NSSAI 1 before i.e., the NSSAA status for S-NSSAI 1 is not there in the AMF 70. Then the AMF 70 may decide to update the status of S-NSSAI 1 from the Allowed NSSAI to a Pending NSSAI. For example, the AMF 70 may determine to include S-NSSAI 1 in not the Allowed NSSAI but the Pending NSSAI.

For example, the AMF 70 may change the attribute of S-NSSAI 1 based on local configuration in the AMF 70 or operator's policy.

For example, the AMF 70 may change the attribute of S-NSSAI 1 based information in the Nudm_SDM_Notification massage from the UDM 75.

For example, the AMF 70 may change the attribute of S-NSSAI 1 based information from the UDM 75 or any other network node (e.g. other core network node).

For example, the AMF 70 may change the attribute of S-NSSAI 1 in a case where the AMF 70 receives, from the UDM 75 or any other network node, information indicating that the NSSAA is required for S-NSSAI 1. S-NSSAI 1 may not be subject to the NSSAA.

For example, step 2 may be triggered by a notification or a message from the UDM 75 or any other network node (e.g. other core network node), or triggered by local configuration in the AMF 70, or triggered by operator's policy.

For example, step 2 may be also triggered in a case where the AMF 70 changes from the status of the S-NSSAI included in the Allowed NSSAI that the S-NSSAI is not subject to the NSSAA procedure, to the status that the S-NSSAI is subject to the NSSAA procedure. The above changing the mapping and the above changing the attribute may be expressed as the above changing the status of the S-NSSAI.

For example, in a case where the AMF 70 changes the status of S-NSSAI(s) included in the Allowed NSSAI or in the Configured NSSAI or in the Subscribed NSSAI (e.g., the AMF 70 changes the mapping related to the S-NSSAI(s) included in the Allowed NSSAI or in the Configured NSSAI or in the Subscribed NSSAI or changes the attribute of the S-NSSAI(s) included in the Allowed NSSAI or in the Configured NSSAI or in the Subscribed NSSAI), the AMF 70 may check whether the S-NSSAI(s) is included in the Allowed NSSAI which has been sent to the UE 3.

In a case where the AMF 70 determines that the S-NSSAI(s) is included in the Allowed NSSAI which has been sent to the UE 3, the AMF 70 may decide to update the status of an S-NSSAI from the Allowed NSSAI to the Pending NSSAI, as mentioned above.

In a case where the AMF 70 determines that the S-NSSAI(s) is not included in the Allowed NSSAI which has been sent to the UE 3, the AMF 70 may decide not to update the status of an S-NSSAI from the Allowed NSSAI to the Pending NSSAI.

Please note that S-NSSAI(s) in the Allowed NSSAI is included in the Configured NSSAI. Hence, the mapping between a VPLMN network slice which is in the Allowed NSSAI and a HPLMN network slice may mean a mapping between a VPLMN network slice which is in the Configured NSSAI and a HPLMN network slice. In addition, the AMF 70 may also change a mapping such as VPLMN S-NSSAI A in the Configured NSSAI (e.g. S-NSSAI A of the Configured NSSAI in the VPLMN) and HPLMN S-NSSAI 1 (e.g. S-NSSAI 1 in the HPLMN) to a mapping such as VPLMN S-NSSAI A and HPLMN S-NSSAI 2 (e.g. S-NSSAI 2 in the HPLMN).

For example, it assumes a case where the AMF 70 changes the mapping such as VPLMN S-NSSAI A in the Configured NSSAI (e.g. S-NSSAI A of the Configured NSSAI in the VPLMN) and HPLMN S-NSSAI 1 (e.g. S-NSSAI 1 in the HPLMN) to a mapping such as VPLMN S-NSSAI A and HPLMN S-NSSAI 2 (e.g. S-NSSAI 2 in the HPLMN). In this case, S-NSSAI 2 is subject to the NSSAA procedure.

This change may be performed by the AMF 70 based on local configuration or operator's policy. This change may be performed by the AMF 70 in a case where the AMF 70 receives the Nudm_SDM_Notification massage. This change may be performed by the AMF 70 in a case where the AMF 70 receives information related to the change from the UDM 75 or any other network node(s).

In this case, the AMF 70 may determine whether S-NSSAI A is included in the Allowed NSSAI which has been sent to the UE 3.

In a case where the AMF 70 determines that S-NSSAI A is included in the Allowed NSSAI which has been sent to the UE 3, the AMF 70 may decide to update the status of S-NSSAI A from the Allowed NSSAI to a Pending NSSAI.

In a case where the AMF 70 determines that S-NSSAI A is not included in the Allowed NSSAI which has been sent to the UE 3, the AMF 70 may decide not to update the status of S-NSSAI A from the Allowed NSSAI to a Pending NSSAI.

For example, it assumes a case where the AMF 70 changes whether the NSSAA is needed for S-NSSAI(s) as mentioned above. For example, the AMF 70 sends, to the UE 3, the Allowed NSSAI including S-NSSAI 1 which is not subject to the NSSAA. The UE 3 holds the Allowed NSSAI including S-NSSAI 1 which is not subject to the NSSAA. After sending the Allowed NSSAI, the AMF 70 changes an attribute of the Configured NSSAI. For example, the AMF 70 changes that an attribute of S-NSSAI 1 included in the Configured NSSAI such that S-NSSAI 1 is subject to the NSSAA.

This change may be performed by the AMF 70 based on local configuration or operator's policy. This change may be performed by the AMF 70 in a case where the AMF 70 receives the Nudm_SDM_Notification massage. This change may be performed by the AMF 70 in a case where the AMF 70 receives information related to the change from the UDM 75 or any other network node(s).

In this case, the AMF 70 may determine whether S-NSSAI 1 is included in the Allowed NSSAI which has been sent to the UE 3.

In a case where the AMF 70 determines that S-NSSAI 1 is included in the Allowed NSSAI which has been sent to the UE 3, the AMF 70 may decide to update the status of S-NSSAI 1 from the Allowed NSSAI to a Pending NSSAI.

In a case where the AMF 70 determines that S-NSSAI 1 is not included in the Allowed NSSAI which has been sent to the UE 3, the AMF 70 may decide not to update the status of S-NSSAI 1 from the Allowed NSSAI to a Pending NSSAI.

The step 2 may be same to step 2 in FIG. 2.

Step 3. The AMF 70 sends, to the UE 3, a UE Configuration Update Command message including 5G-GUTI, Allowed NSSAI, Mapping of Allowed NSSAI, Configured NSSAI for the Serving PLMN, Mapping of Configured NSSAI and Pending NSSAI. The 5G-GUTI is a temporary identifier to the UE 3 that the AMF 70 has assigned to the UE 3. The network slice related information is set based on the decision made in step 2.

For example, the Pending NSSAI is included in the UE Configuration Update Command message if an S-NSSAI in the Allowed NSSAI in the UE 3 becomes an S-NSSAI that requires NSSAA but this S-NSSAI has not been authenticated via the NSSAA procedure in the VPLMN yet.

For example, in a case where the AMF 70 changes the mapping such as VPLMN S-NSSAI A in the Allowed NSSAI (e.g. S-NSSAI A of the Allowed NSSAI in the VPLMN) and HPLMN S-NSSAI 1 (e.g. S-NSSAI 1 in the HPLMN) to the mapping such as VPLMN S-NSSAI A and HPLMN S-NSSAI 2 (e.g. S-NSSAI 2 in the HPLMN) in step 2, the AMF 70 may send the UE Configuration Update Command message including at least the Pending NSSAI which includes S-NSSAI A.

For example, in a case where the AMF 70 changes the attribute of S-NSSAI 1 such that S-NSSAI 1 is subject to the NSSAA in step 2, the AMF 70 may send the UE Configuration Update Command message including at least the Pending NSSAI which include S-NSSAI 1.

In one example, the AMF 70 can send a separate Configuration Update

Command message to deliver the Pending NSSAI and other information elements e.g. Configured NSSAI to the UE 3.

In another example, if a Registration Accept message is pending, i.e. not sent by the AMF 70 yet, then the AMF 70 delivers the Pending NSSAI and/or other parameters to the UE 3 in the Registration Accept message. For example, the AMF 70 may send at least the Pending NSSAI by using the Registration Accept message.

Step 4. Upon reception of the UE Configuration Update Command message in step 3 (or upon reception of the Registration Accept message in step 3), the UE 3 updates the network slice related storage information in the UE 3.

If the Pending NSSAI is received in step 3 and an S-NSSAI received within the Pending NSSAI is stored in the Allowed NSSAI in the UE 3, the UE 3 removes the received S-NSSAI from the storage of the Allowed NSSAI and stores it to the Pending NSSAI in the UE 3.

For example, the UE 3 holds the Allowed NSSAI including S-NSSAI A (e.g., S-NSSAI A is not subject to the NSSAA at the time when the UE receives the Allowed NSSAI) in step 0. Then the mapping related to S-NSSAI A as mentioned above is changed in step 2. In this case, the UE 3 receives the Pending NSSAI including S-NSSAI A in step 3, then UE 3 removes S-NSSAI A from the Allowed NSSAI and stores S-NSSAI A in the Pending NSSAI in step 4.

For example, the UE 3 holds the Allowed NSSAI including S-NSSAI 1 (e.g., S-NSSAI 1 is not subject to the NSSAA at the time when the UE receives the Allowed NSSAI) in step 0. Then, the attribute of S-NSSAI 1 as mentioned above is changed in step 2. In this case, the UE 3 receives the Pending NSSAI including S-NSSAI 1 in step 3, then UE 3 removes S-NSSAI 1 from the Allowed NSSAI and stores S-NSSAI 1 in the Pending NSSAI in step 4.

Step 5. The UE 3 sends a UE Configuration Update Complete message to the AMF 70. For example, the UE 3 sends the UE Configuration Update Complete message in a case where the UE 3 receives the UE Configuration Update Command message and the UE 3 performs the process in step 4.

If the UE 3 receives the Registration Accept message from the AMF 70 then the UE 3 sends a Registration Complete message to the AMF 70 in step 5.

Step 6. If the AMF 70 decides to update the status of an S-NSSAI from the Allowed NSSAI to an S-NSSAI from the Pending NSSAI in step 2, the AMF 70 triggers the Network Slice-Specific Authentication and Authorization (NSSAA) procedure as described in the section 4.2.9.2 in 3GPP TS 23.502[3].

For example, in a case where the mapping related to S-NSSAI A as mentioned above is changed, the AMF 70 triggers the NSSAA procedure for S-NSSAI A.

For example, the attribute of S-NSSAI 1 as mentioned above is changed, the AMF 70 triggers the NSSAA procedure for S-NSSAI 1.

For example, the AMF 70 may send the Allowed NSSAI including S-NSSAI A after completion of the NSSAA procedure for S-NSSAI A. For example, the AMF 70 may send, to the UE 3, the Allowed NSSAI including S-NSSAI A after completion of the NSSAA procedure for S-NSSAI A.

For example, the AMF 70 may send the Allowed NSSAI including S-NSSAI 1 after completion of the NSSAA procedure for S-NSSAI 1. For example, the AMF 70 may send, to the UE 3, the Allowed NSSAI including S-NSSAI 1 after completion of the NSSAA procedure for S-NSSAI 1.

The step 6 may be performed by the AMF 70 in a case where the AMF 70 receives the UE Configuration Update Complete message.

The step 6 may be performed by the AMF 70 after the AMF 70 decides to update the status of an S-NSSAI from the Allowed NSSAI to the Pending NSSAI in step 2.

The step 6 may be performed by the AMF 70 after step 2 and before step 3

Step 7. If there is PDU session(s) that is related to an S-NSSAI that is moved to the Pending NSSAI from the Allowed NSSAI, the AMF 70 may initiate the PDU Session Release procedure for all related PDU session(s) as described in the section 4.3.4 in 3GPP TS 23.502[3].

For example, the PDU Session Release procedure may be initiated by the AMF 70 if the NSSAA procedure in step 6 is unsuccessful.

For example, the PDU Session Release procedure may not be initiated by the AMF 70 if the NSSAA procedure in step 6 is successful.

According to First example of the First Aspect, for example, the AMF 70 sends the Pending NSSAI including S-NSSAI(s) that is subject to the NSSAA, and the AMF 70 triggers the NSSAA for the S-NSSAI(s). This can solve the above-mentioned problem. For example, this can prevent the unauthorized use of network slice(s) by the UE.

### Variant 1 of First Example of the First Aspect

When the UE 3 receives the UE Configuration Update Command message including the Pending NSSAI in step 3, the UE 3 may initiate the PDU Session Release procedure as described in the section 4.3.4 in 3GPP TS 23.502[3] for all PDU session(s) related to S-NSSAI(s) that is moved to the Pending NSSAI from the Allowed NSSAI.

### Variant 2 of First Example of the First Aspect

It assumes that the UE 3 is registered to the same AMF 70 via both 3GPP access and non-3GPP access and there is the same S-NSSAI, that is mapped to the same Subscribed S-NSSAI, stored as the Allowed S-NSSAI for both accesses in the UE 3 and the AMF 70. For example, the UE 3 is registered to the same AMF 70 via both 3GPP access and non-3GPP access and there is the same S-NSSAI 1, that is mapped to same S-NSSAI 2 (e.g. the same Subscribed S-NSSAI), stored as the Allowed S-NSSAI for both accesses in the UE 3 and the AMF 70 in step 0. Then, the mapped S-NSSAI (e.g., S-NSSAI 2 or the mapped Subscribed S-NSSAI or the mapped Subscribed S-NSSAI that is not subject to the NSSAA) is changed to another S-NSSAI (e.g., S-NSSAI 3 or another Subscribed S-NSSAI) that is subject to the NSSAA in the AMF 70. This can be considered as another trigger for the AMF 70 at step 2. The AMF 70 can take one out of the following actions.
The AMF 70 sends the UE Configuration Update Command message to the UE 3 as indicated in step 3 using 3GPP access only.
The AMF 70 sends the UE Configuration Update Command message to the UE 3 as indicated in step 3 using 3GPP access if the UE 3 is not in the CM-CONNECTED state (or CM-CONNECTED mode) over the Non-3GPP access.
The AMF 70 sends the UE Configuration Update Command message to the UE 3 as indicated in step 3 using Non-3GPP access if the UE 3 is in the CM-CONNECTED state (or CM-CONNECTED mode) over the Non-3GPP access.
The AMF 70 sends the UE Configuration Update Command message to the UE 3 as indicated in step 3 twice using both 3GPP access and Non-3GPP access. For example, the AMF 70 may send the first UE Configuration Update Command message to the UE 3 as indicated in step 3 using 3GPP access and the second UE Configuration Update Command message to the UE 3 using Non-3GPP access.

### Variant 3 of First example of the First Aspect

In step 2, the AMF 70 may determine whether S-NSSAI(s) before the change is subject to the NSSAA procedure.

For example, it assumes a case where the AMF 70 changes a mapping such as VPLMN S-NSSAI A in the Allowed NSSAI (e.g. S-NSSAI A of the Allowed NSSAI in the VPLMN) and HPLMN S-NSSAI 1 (e.g. S-NSSAI 1 in the HPLMN) to a mapping such as VPLMN S-NSSAI A and HPLMN S-NSSAI 2 (e.g. S-NSSAI 2 in the HPLMN).

In this case, the AMF 70 determines whether S-NSSAI 1 is subject to the NSSAA procedure. For example, the AMF 70 may determine whether S-NSSAI 1 is subject to the NSSAA procedure before deciding to update the status of S-NSSAI from Allowed NSSAI to Pending NSSAI.

In a case where the AMF 70 determines that S-NSSAI 1 is subject to the NSSAA procedure, the AMF 70 may not perform the processes in steps 2 and 3.

In addition, the AMF 70 may determine whether the NSSAA procedure for S-NSSAI 1 has been done. For example, the AMF 70 may determine whether the NSSAA procedure for S-NSSAI 1 has been done before deciding to update the status of S-NSSAI from Allowed NSSAI to Pending NSSAI. In a case where the AMF 70 determines that the NSSAA procedure for S-NSSAI 1 has been done, the AMF 70 may not perform the processes in steps 2 and 3.

The AMF 70 may store information indicating that the NSSAA procedure has been done and use the information for determining whether the NSSAA procedure for S-NSSAI has been done. For example, the AMF 70 may store the information in a case where the AMF 70 determines that the NSSAA procedure has been done (e.g., in a case where the AMF 70 performs UE configuration update procedure during the NSSAA procedure).

In a case where the AMF 70 determines that S-NSSAI 1 is not subject to the NSSAA procedure, the AMF 70 may perform the processes in steps 2 and 3.

Note that, it may need that the NSSAA procedure may be performed for each S-NSSAI. Hence, even if the AMF 70 determines that S-NSSAI 1 is subject to the NSSAA procedure, the AMF 70 may perform the processes in steps 2 and 3.

For example, it assumes a case where the AMF 70 changes the attribute of S-NSSAI 1 as mentioned above.

In this case, the AMF 70 determines whether S-NSSAI 1 is subject to the NSSAA procedure (or the AMF 70 determines whether the NSSAA procedure for S-NSSAI 1 has been done). For example, the AMF 70 may determine whether S-NSSAI 1 is subject to the NSSAA procedure (or the AMF 70 determines whether the NSSAA procedure for S-NSSAI 1 has been done) before deciding to update the status of S-NSSAI from Allowed NSSAI to Pending NSSAI.

In a case where the AMF 70 determines that S-NSSAI 1 is subject to the NSSAA procedure (or the AMF 70 determines that the NSSAA procedure for S-NSSAI 1 has been done), the AMF 70 may not perform the processes in steps 2 and 3.

In a case where the AMF 70 determines that S-NSSAI 1 is not subject to the NSSAA procedure (or the AMF 70 determines that the NSSAA procedure for S-NSSAI 1 has not been done), the AMF 70 may perform the processes in steps 2 and 3.

Note that, it may need that the NSSAA procedure may be performed every time. Hence, even if the AMF 70 determines that S-NSSAI 1 is subject to the NSSAA procedure (or the AMF 70 determines that the NSSAA procedure for S-NSSAI 1 has been done), the AMF 70 may perform the processes in steps 2 and 3.

The AMF 70 may store information indicating that the NSSAA procedure has been done and use the information for determining whether the NSSAA procedure has been done. For example, the AMF 70 may store the information in a case where the AMF 70 determines that the NSSAA procedure has been done (e.g., in a case where the AMF 70 performs UE configuration update procedure during the NSSAA procedure).

The Variant 3 of First example of the First Aspect may be applied to Second example of the First Aspect.

### Second Example of the First Aspect

The Second example of the First Aspect discloses a method where AMF 70 updates a mapping of an S-NSSAI from the Configured NSSAI and/or from the Allowed NSSAI to a Subscribed S-NSSAI that is subject to the NSSAA and no NSSAA procedure for that S-NSSAI has taken place in the PLMN.

In this case, the AMF 70 triggers the NSSAA procedure for the newly mapped Subscribed S-NSSAI. While the NSSAA procedure for the newly mapped Subscribed S-NSSAI is running, the AMF 70 rejects any request for a service from the UE 3 for the newly mapped Subscribed S-NSSAI.

The detailed process of the Second example of the First Aspect is described below, with reference to FIG. 2.

Step 0. The UE 3 is registered with a serving PLMN and a 5G-GUTI has been assigned by the AMF 70 to the UE 3. The UE 3 holds at least one of a Configured NSSAI and an Allowed NSSAI. The UE 3 may hold a Rejected NSSAI. The AMF 70 may hold the Configured NSSAI for the UE 3 and the Allowed NSSAI for the UE 3. The AMF 70 may hold the Rejected NSSAI for the UE 3. For example, at least one of S-NSSAIs in the Configured NSSAI is subject to the NSSAA while other S-NSSAI(s) in the Configured NSSAI is not subject to the NSSAA. For example, at least one of S-NSSAIs in the Allowed NSSAI is subject to a NSSAA while other S-NSSAI(s) in the Allowed NSSAI is not subject to a NSSAA. The UE 3 may receive at least one of the Allowed NSSAI, the Configured NSSAI and the Rejected NSSAI during registration procedure.

For example, the UE 3 may be an outbound roamer visiting a VPLMN. In this case, the AMF 70 maps a Subscribed S-NSSAI to an S-NSSAI of the VPLMN. The UE 3 may know the mapping of the Subscribed S-NSSAI to the S-NSSAI of the VPLMN (e.g. the UE 3 may receive information indicating the mapping from the AMF 70).

The step 0 may be same to step 0 in FIG. 1.

Step 1. The UDM 75 sends an Nudm_SDM_Notification massage to the AMF 70 including updated subscriber data with regard to the network slice(s) (e.g. the network slice mapping).

Note that the step I can be considered as a trigger to the AMF decision in step 2. For example, if the UDM 75 updates an attribute of NSSAA for the S-NSSAI(s) that is configured to the UE 3, from “NSSAA not required” to “NSSAA required”, this may be a trigger to the AMF decision in step 2.

The step 1 may be same to step 1 in FIG. 1.

Step 2. The AMF 70 decides to update the status of an S-NSSAI from an Allowed NSSAI to a Pending NSSAI.

The AMF 70 marks such S-NSSAI as the Pending NSSAI in the AMF 70.

For example, in a case where the AMF 70 decides to update the status of an S-NSSAI from an Allowed NSSAI to a Pending NSSAI, the AMF 70 may remove the S-NSSAI from the Allowed NSSAI of the AMF 70 and may store the S-NSSAI in the Pending NSSAI of the AMF 70.

For example, the AMF 70 may decide to update the status of an S-NSSAI from an Allowed NSSAI to a Pending NSSAI in a case where the AMF 70 receives the Nudm_SDM_Notification massage.

For example, the AMF 70 may decide to update the status of an S-NSSAI from an Allowed NSSAI to a Pending NSSAI based on local configuration in the AMF 70 or operator's policy.

For example, the AMF 70 updates the mapping between the assigned S-NSSAI (e.g., S-NSSAI(s) in the Allowed NSSAI or S-NSSAI(s) in the Subscribed NSSAI or S-NSSAI(s) in the Configured NSSAI) and the Subscribed S-NSSAI based on local configuration update, and the newly mapped Subscribed S-NSSAI is subject to the NSSAA.

In another example, the AMF 70 updates a mapping between the assigned S-NSSAI and the Subscribed S-NSSAI based on local configuration update and the newly mapped Subscribed S-NSSAI is subject to the NSSAA and the newly mapped Subscribed S-NSSAI has never been authenticated and authorized for NSSAA in the PLMN.

In another example, the AMF 70 receives the Nudm_SDM_Notification massage from the UDM 75 including updated subscriber data for the mapped Subscribed S-NSSAI where an attribute of NSSAA for the mapped Subscribed S-NSSAI is changed from “NSSAA not required” to “NSSAA required”.

For example, as mentioned in First example of the First Aspect, the AMF 70 changes a mapping such as VPLMN S-NSSAI A in the Allowed NSSAI (e.g. S-NSSAI A of the Allowed NSSAI in the VPLMN) and HPLMN S-NSSAI 1 (e.g. S-NSSAI 1 in the HPLMN) to a mapping such as VPLMN S-NSSAI A and an HPLMN S-NSSAI 2 (e.g. S-NSSAI 2 in the HPLMN). In a case where S-NSSAI 2 is subject to the NSSAA, the NSSAA procedure has not been executed for S-NSSAI 2 before i.e., the NSSAA status for S-NSSAI 2 is not there in the AMF 70. Then the AMF 70 may decide to update the status of S-NSSAI A from an Allowed NSSAI to a Pending NSSAI. In addition, for example, the AMF 70 may determine to include S-NSSAI A in not the Allowed NSSAI but the Pending NSSAI. Further, the AMF 70 may mark S-NSSAI A as the Pending NSSAI in the AMF 70 (e.g. the AMF 70 stores S-NSSAI A in the Pending NSSAI).

For example, as mentioned in First example of the First Aspect, the AMF 70 changes the attribute of S-NSSAI 1, and the AMF 70 may decide to update the status of S-NSSAI 1 from an Allowed NSSAI to a Pending NSSAI. In addition, for example, the AMF 70 may determine to include S-NSSAI 1 in not the Allowed NSSAI but the Pending NSSAI. Further, the AMF 70 may mark S-NSSAI 1 as the Pending NSSAI in the AMF 70 (e.g. the AMF 70 stores S-NSSAI 1 in the Pending NSSAI).

The step 2 may be same to step 2 in FIG. 1.

Step 3. The AMF 70 triggers the Network Slice-Specific Authentication and Authorization (NSSAA) procedure as described in the section 4.2.9.2 in 3GPP TS 23.502[3] for the Pending NSSAI. For example, the AMF 70 triggers the NSSAA procedure in a case where the AMF 70 decides to update the status of the S-NSSAI from the Allowed NSSAI to the Pending NSSAI in step 2.

For example, in a case where the AMF 70 changes the mapping such as VPLMN S-NSSAI A in the Allowed NSSAI and HPLMN S-NSSAI 1 to the mapping such as VPLMN S-NSSAI A and HPLMN S-NSSAI 2 as mentioned above, the AMF 70 may trigger the NSSAA procedure for S-NSSAI 2.

For example, in a case where the AMF 70 changes the attribute of S-NSSAI 1 as mentioned above, the AMF 70 may trigger the NSSAA procedure for S-NSSAI 1.

Note that it might take some time for the AMF 70 to initiate the NSSAA procedure especially in case of multiple S-NSSAIs have undergone NSSAA status update as the NSSAA procedure for each S-NSSAI may be run sequentially, one by one.

Step 4. In one example, triggered by an application in the UE 3 that is associated with the S-NSSAI as per the traffic routing policy or the Network Slice Selection Policy (NSSP) according to the URSP rules as defined in 3GPP TS 23.503[4], the UE 3 sends a NAS message to the AMF 70 including the S-NSSAI. The S-NSSAI may be marked as the Pending NSSAI in the AMF 70 (e.g., the S-NSSAI may be included in the Pending NSSAI of the AMF 70). For example, the UE 3 may send the NAS message to request service(s) related to the S-NSSAI.

The NAS message may be a UL NAS Transport message, a Service Request message, a PDU Session Establishment Request message, other existing NAS message or a new NAS message.

Step 5. Upon the reception of the NAS message in step 4, the AMF 70 examines whether the received S-NSSAI from the UE 3 is marked and stored as a Pending NSSAI within the AMF 70, e.g. stored in the UE 3 context within the AMF 70 (e.g., the AMF 70 may determine whether the received S-NSSAI from the UE 3 is in the Pending NSSAI of the AMF 70). If the S-NSSAI on which the UE 3 requested a service via a NAS message to the AMF 70 is marked as a Pending NSSAI (e.g., in a case where the AMF 70 determines that the received S-NSSAI from the UE 3 is in the Pending NSSAI of the AMF 70), the AMF 70 rejects the request for a service by the UE 3 by sending a NAS Reject message to the UE 3. The NAS Reject message includes a cause value “Not accepted due to NSSAA pending status” or any other expression which indicates that the S-NSSAI on which the UE 3 requires a service is with a Pending status in the AMF 70, i.e. it is marked as Pending NSSAI and the service request from the UE 3 cannot be accepted by the AMF 70. The cause value may indicate that the S-NSSAI on which the UE 3 requires service is in the Pending NSSAI of the AMF 70. The cause value may indicate that attribute of the S-NSSAI on which the UE 3 requires service is changed. The cause value may indicate that attribute of the S-NSSAI on which the UE 3 requires service is changed from status that the S-NSSAI is not subject to the NSSAA procedure to status that the S-NSSAI is subject to the NSSAA procedure. The cause value may indicate that status indicating that the S-NSSAI is not subject to NSSAA procedure is changed to status indicating that the S-NSSAI is subject to the NSSAA procedure. The cause value provided from AMF 70 to the UE 3 in a NAS message can be a new cause value or an existing cause value.

The UE 3 may suspend or stop requesting the service related to the S-NSSAI in a case where the UE 3 receives the cause value. For example, the UE 3 may suspend or stop requesting a PDU session(s) related to the S-NSSAI in a case where the UE 3 receives the cause value. The requesting the service or the requesting the PDU session(s) may be expressed as a process related to the S-NSSAI.

The NAS Reject message may include a Backoff timer value. The Backoff timer value indicates to the UE 3 for how long the UE 3 is suspended on the Pending NSSAI, i.e., back-off before the UE 3 requests any services on the Pending NSSAI. The UE 3 can re-start requesting any services with the S-NSSAI once the backoff timer which is set to the Backoff timer value is expired in the UE 3.

The NAS Reject message may be a DL NAS Transport message, a Service Reject message, a PDU Session Establishment Reject message or any other existing NAS message or a new NAS message.

Step 6. If there is PDU session(s) that is related to the S-NSSAI that is marked as the Pending NSSAI in the AMF 70 (e.g., in a case where there is PDU session(s) related to the S-NSSAI(s) that is stored in the Pending NSSAI in the AMF 70), the AMF 70 may initiate the PDU Session Release procedure for all related PDU session(s) (e.g., the PDU session(s) related to the S-NSSAI(s) that is stored in the Pending NSSAI in the AMF 70) as described in the section 4.3.4 in 3GPP TS 23.502[3].

For example, the PDU Session Release procedure may be initiated by the AMF 70 if the NSSAA procedure in step 3 is unsuccessful.

For example, the PDU Session Release procedure may not be initiated by the AMF 70 if the NSSAA procedure in step 3 is successful.

Step 7. If the NSSAA procedure for the Pending NSSAI completes successfully, the AMF 70 adds the Pending NSSAI in the list of Allowed NSSAI for the UE 3 (e.g. the AMF 70 moves S-NSSAI(s) included in the Pending NSSAI (e.g., the Pending NSSAI stored in step 2) to the Allowed NSSAI) and the AMF 70 updates the Allowed NSSAI in the UE 3 via the UE Configuration Update message. In addition, the AMF 70 changes the status of the S-NSSAI marked as Pending NSSAI by moving it in the Allowed NSSAI, i.e. the S-NSSAI which has finished the NSSAA procedure successfully is no more marked as Pending NSSAI within the AMF 70 and AMF 70 no longer rejects requests for a service by the UE 3 on that S-NSSAI. For example, if the NSSAA procedure for the Pending NSSAI completes successfully, the AMF 70 adds S-NSSAI(s) included in the Pending NSSAI to the Allowed NSSAI in the AMF 70 and removes the S-NSSAI(s) from the Pending NSSAI, and the AMF 70 sends the Allowed NSSAI to the UE 3 via the UE Configuration Update message to update the Allowed NSSAI in the UE 3. In a case where the UE 3 receives the Allowed NSSAI from the AMF 70, the UE 3 may update the Allowed NSSAI in the UE 3 by using the received Allowed NSSAI.

If the NSSAA procedure for the Pending NSSAI fails, the AMF 70 adds the Pending NSSAI in the list of a Rejected NSSAI for the UE 3 (e.g. the AMF 70 moves S-NSSAI(s) included in the Pending NSSAI to the Rejected NSSAI) and the AMF 70 updates the Rejected NSSAI in the UE 3 via the UE Configuration Update message. For example, the AMF 70 may store the Rejected NSSAI. In addition, the AMF 70 changes the status of the S-NSSAI marked as Pending NSSAI by moving it in the Rejected NSSAI. For example, if the NSSAA procedure for the Pending NSSAI fails, the AMF 70 adds S-NSSAI(s) included in the Pending NSSAI to the Rejected NSSAI in the AMF 70 and removes the S-NSSAI(s) from the Pending NSSAI, and the AMF 70 sends the Rejected NSSAI to the UE 3 via the UE Configuration Update message to update the Rejected NSSAI in the UE 3. In a case where the UE 3 receives the Rejected NSSAI from the AMF 70, the UE 3 may update the Rejected NSSAI in the UE 3 by using the received Rejected NSSAI. For example, in a case where the UE 3 receives the Rejected NSSAI including S-NSSAI(s) from the AMF 70, the UE 3 may remove the S-NSSAI(s) from the Allowed NSSAI in the UE 3 and add the S-NSSAI(s) to the Rejected NSSAI in the UE 3. For example, the UE 3 may store the Rejected NSSAI.

According to Second example of the First Aspect, for example, the AMF 70 rejects the NAS message from the UE 3. This can solve the above-mentioned problem. For example, this can prevent the unauthorized use of network slice(s) by the UE.

### Variant 1 of Second Example of the First Aspect

When the UE 3 is involved in the Network Slice-Specific Authentication and Authorization (NSSAA) procedure with an S-NSSAI in step 3 (e.g., in a case where the NSSAA procedure for the S-NSSAI is ongoing), the UE 3 may suspend (or stop), i.e., may be backed-off, for requesting any service(s) with the S-NSSAI. The UE 3 may re-start requesting any service(s) with the S-NSSAI once the NSSAA procedure is completed successfully.

For example, in a case where the NSSAA procedure for S-NSSAI 2 is performed in step 3 as mentioned above (e.g., in a case where the NSSAA procedure for S-NSSAI 2 is ongoing), the UE 3 may suspend or may be backed-off for requesting any service(s) with S-NSSAI 2 (or S-NSSAI(s) mapped to S-NSSAI 2, or Subscribed S-NSSAI(s) mapped to S-NSSAI 2), or may not use S-NSSAI 2 (or S-NSSAI(s) mapped to S-NSSAI 2, or Subscribed S-NSSAI(s) mapped to S-NSSAI 2) for requesting any service(s). In addition, the UE 3 may re-start requesting any service(s) with S-NSSAI 2 (or S-NSSAI(s) mapped to S-NSSAI 2, or Subscribed S-NSSAI(s) mapped to S-NSSAI 2) once the NSSAA procedure for S-NSSAI 2 is completed successfully. Note that, the UE 3 may know that the NSSAA procedure is for S-NSSAI 2 (e.g., the UE 3 may know that the NSSAA procedure for S-NSSAI 2 is performed or is ongoing) based on information during the NSSAA procedure (e.g., S-NSSAI 2 may be informed to the UE 3 during the NSSAA procedure, then the UE 3 can know that the NSSAA procedure is for S-NSSAI 2 and is ongoing).

For example, in a case where the NSSAA procedure for S-NSSAI 1 is performed in step 3 as mentioned above (e.g., in a case where the NSSAA procedure for S-NSSAI 1 is ongoing), the UE 3 may suspend or may be backed-off for requesting any service(s) with S-NSSAI 1, or may not use S-NSSAI 1 for requesting any service(s). In addition, the UE 3 may re-start requesting any service(s) with S-NSSAI 1 once the NSSAA procedure for S-NSSAI 1 is completed successfully. Note that, the UE 3 may know that the NSSAA procedure is for S-NSSAI 1 (e.g., the UE 3 may know that the NSSAA procedure for S-NSSAI 1 is performed or is ongoing) based on information during the NSSAA procedure (e.g., S-NSSAI 1 may be informed to the UE 3 during the NSSAA procedure, then the UE 3 can know that the NSSAA procedure is for S-NSSAI 1 and is ongoing).

The Variant 1 of Second example of the First Aspect may be applied to First example of the First Aspect. For example, when the UE 3 is involved in the Network Slice-Specific Authentication and Authorization (NSSAA) procedure with an S-NSSAI in step 6 of FIG. 1, the UE 3 may suspend, i.e., may be backed-off, for requesting any service(s) with the S-NSSAI. The UE 3 may re-start requesting any service(s) with the S-NSSAI once the NSSAA procedure is completed successfully.

### Variant 2 of Second Example of the First Aspect

When the UE 3 is involved in the Network Slice-Specific Authentication and Authorization (NSSAA) procedure with an S-NSSAI in step 3 (e.g., in a case where the NSSAA procedure for the S-NSSAI is ongoing), the UE 3 may update the network slice related storage information in the UE 3.

If the S-NSSAI for the NSSAA procedure in step 3 is stored in the Allowed NSSAI in the UE 3, the UE 3 may remove the S-NSSAI from the storage of the Allowed NSSAI and stores it to the Pending NSSAI in the UE 3.

For example, in a case where the NSSAA procedure for S-NSSAI 2 is performed in step 3 as mentioned above (e.g., in a case where the NSSAA procedure for S-NSSAI 2 is ongoing), the UE 3 may determine whether S-NSSAI 2 (or S-NSSAI(s) mapped to S-NSSAI 2, or Subscribed S-NSSAI(s) mapped to S-NSSAI 2) is included in an Allowed NSSAI of the UE 3.

In a case where the UE 3 determines that S-NSSAI 2 (or S-NSSAI(s) mapped to S-NSSAI 2, or Subscribed S-NSSAI(s) mapped to S-NSSAI 2) is included in the Allowed NSSAI of the UE 3, the UE 3 may remove S-NSSAI 2 (or S-NSSAI(s) mapped to S-NSSAI 2, or Subscribed S-NSSAI(s) mapped to S-NSSAI 2) from the Allowed NSSAI and may store S-NSSAI 2 (or S-NSSAI(s) mapped to S-NSSAI 2, or Subscribed S-NSSAI(s) mapped to S-NSSAI 2) in the Pending NSSAI of the UE 3.

Note that, the UE 3 may know that the NSSAA procedure is for S-NSSAI 2 (e.g., the UE 3 may know that the NSSAA procedure for S-NSSAI 2 is performed or is ongoing) based on information during the NSSAA procedure (e.g., S-NSSAI 2 may be informed to the UE 3 during the NSSAA procedure, then the UE 3 can know that the NSSAA procedure is for S-NSSAI 2 and is ongoing). The UE 3 may determine whether S-NSSAI 2 (or S-NSSAI(s) mapped to S-NSSAI 2, or Subscribed S-NSSAI(s) mapped to S-NSSAI 2) is included in the Allowed NSSAI of the UE 3 in a case where the UE 3 receives S-NSSAI 2 during the NSSAA procedure.

For example, in a case where the NSSAA procedure for S-NSSAI 1 is performed in step 3 as mentioned above (e.g., in a case where the NSSAA procedure for S-NSSAI 1 is ongoing), the UE 3 may determine whether S-NSSAI 1 is included in an Allowed NSSAI of the UE 3.

In a case where the UE 3 determines that S-NSSAI 1 is included in the Allowed NSSAI of the UE 3, the UE 3 may remove S-NSSAI 1 from the Allowed NSSAI and may store S-NSSAI 1 in the Pending NSSAI of the UE 3.

Note that, the UE 3 may know that the NSSAA procedure is for S-NSSAI 1 (e.g., the UE 3 may know that the NSSAA procedure for S-NSSAI 1 is performed or is ongoing) based on information during the NSSAA procedure (e.g., S-NSSAI 1 may be informed to the UE 3 during the NSSAA procedure, then the UE 3 can know that the NSSAA procedure is for S-NSSAI 1 and is ongoing). The UE 3 may determine whether S-NSSAI 1 is included in the Allowed NSSAI of the UE 3 in a case where the UE 3 receives S-NSSAI 1 during the NSSAA procedure.

### Variant 3 of Second Example of the First Aspect

The UE 3 may manage all mapped Subscribed S-NSSAI with the Allowed NSSAI by determining whether the mapped Subscribed S-NSSAI has ever been authenticated and authorized successfully in the PLMN or not.

In a case where the UE 3 is involved in the Network Slice-Specific Authentication and Authorization (NSSAA) procedure in step 3, the UE 3 may check whether the S-NSSAI for the NSSAA procedure has been ever authenticated and authorized successfully in the PLMN with NSSAA procedure.

For example, the UE 3 may store information indicating that the S-NSSAI for the NSSAA procedure has been ever authenticated and authorized successfully in the PLMN with NSSAA procedure in a case where the UE 3 performs UE configuration update procedure during the NSSAA procedure (e.g., in a case where the UE 3 receives the Allowed NSSAI including the S-NSSAI during the UE configuration update procedure in the NSSAA procedure).

The UE 3 may use the information indicating that the S-NSSAI for the NSSAA procedure has been ever authenticated and authorized successfully in the PLMN with NSSAA procedure, for checking whether the S-NSSAI for the NSSAA procedure has been ever authenticated and authorized successfully in the PLMN with NSSAA procedure.

If the UE 3 determines that the S-NSSAI in step 3 has ever been authenticated and authorized successfully in the PLMN, the UE 3 may keep the S-NSSAI in the storage of the Allowed NSSAI, otherwise the UE 3 removes the S-NSSAI from the storage of the Allowed NSSAI and stores it to the Pending NSSAI in the UE 3. If the UE 3 determines that the S-NSSAI in step 3 has ever been authenticated and authorized successfully in the PLMN, the UE 3 may keep all related PDU session(s) to the S-NSSAI.

For example, in a case where the UE 3 receives the Allowed NSSAI including a S-NSSAI during the UE configuration update procedure in a first NSSAA procedure in step 0, the UE 3 may store the information indicating that the S-NSSAI for the NSSAA procedure has been ever authenticated and authorized successfully in the PLMN with NSSAA procedure.

After the first NSSAA procedure, the second NSSAA procedure is performed in step 3.

In this case, in a case where the UE 3 receives the S-NSSAI during the second NSSAA procedure, the UE 3 determines whether the S-NSSAI has ever been authenticated and authorized successfully in the PLMN.

In this case, as the UE 3 has the information indicating that the S-NSSAI for the NSSAA procedure has been ever authenticated and authorized successfully in the PLMN with NSSAA procedure, the UE 3 determines that the S-NSSAI has ever been authenticated and authorized successfully in the PLMN. Then the UE 3 keeps the S-NSSAI in the Allowed NSSAI.

In a case where the UE 3 does not have the information that the S-NSSAI for the NSSAA procedure has been ever authenticated and authorized successfully in the PLMN with NSSAA procedure, the UE 3 may determine that the S-NSSAI has not been authenticated and authorized successfully in the PLMN. Then the UE 3 may remove the S-NSSAI from the Allowed NSSAI and may store the S-NSSAI to the Pending NSSAI in the UE 3.

For example, when the UE 3 moves to another PLMN, the UE 3 may remove all information related to the NSSAA procedure for the Allowed NSSAI in the previous serving PLMN. For example, in a case where the UE 3 moves to another PLMN, the UE 3 may remove or delete the information indicating that the S-NSSAI for the NSSAA procedure has been ever authenticated and authorized successfully in the PLMN with NSSAA procedure.

In another example, when the UE 3 is involved in the NSSAA procedure for an S-NSSAI that is stored in the Allowed NSSAI in UE 3, the UE 3 can refer to this management data for the S-NSSAI and may judge whether the NSSAA procedure is either the Network Slice-Specific Authentication and Authorization procedure or the Network Slice-Specific Re-authentication and Re-authorization procedure. “judges whether the NSSAA procedure is either the Network Slice-Specific Authentication and Authorization procedure or the Network Slice-Specific Re-authentication and Re-authorization procedure” may be expressed as “judges whether the NSSAA procedure is reinitiated (or restarted or reperformed)” or “judges whether the NSSAA procedure is initiated (or started or performed) again” or “judges whether the NSSAA procedure is for the first time”.

The UE 3 may use the information indicating that the S-NSSAI for the NSSAA procedure has been ever authenticated and authorized successfully in the PLMN with NSSAA procedure, for checking whether the NSSAA procedure is either the Network Slice-Specific Authentication and Authorization procedure or the Network Slice-Specific Re-authentication and Re-authorization procedure.

If the UE 3 recognizes the NSSAA procedure as the Network Slice-Specific Re-authentication and Re-authorization procedure, the UE 3 may keep the S-NSSAI in the storage of the Allowed NSSAI and may keep all related PDU session(s) to the S-NSSAI as they are. The Network Slice-Specific Re-authentication and Re-authorization procedure may be expressed as reinitiated NSSAA procedure or restarted NSSAA procedure or reperformed NSSAA procedure.

For example, in a case where the UE 3 stores the information indicating that S-NSSAI 1 for the NSSAA procedure has been ever authenticated and authorized successfully in the PLMN with NSSAA procedure and the UE 3 receives information related to S-NSSAI 1 during the current NSSAA procedure (e.g., the

UE 3 receives S-NSSAI 1 during the current NSSAA procedure), the UE 3 may determine that the current NSSAA procedure as the Network Slice-Specific Re-authentication and Re-authorization procedure for S-NSSAI 1 (e.g., the UE may determine that the current NSSAA procedure is reinitiated NSSAA procedure or restarted NSSAA procedure or reperformed NSSAA procedure). In this case, the UE 3 may keep S-NSSAI 1 in the Allowed NSSAI. In addition, the UE 3 may keep PDU session(s) related to the S-NSSAI 1 as they are, if the PDU session(s) related to the S-NSSAI 1 is established.

If the UE 3 recognizes the NSSAA procedure as the Network Slice-Specific Authentication and Authorization procedure, the UE 3 may remove the S-NSSAI from the storage of the Allowed NSSAI and may store it to the Pending NSSAI in the UE 3. The UE 3 may initiate the PDU Session Release procedure for those of the PDU Sessions related to the S-NSSAI.

For example, in a case where the UE 3 does not store the information indicating that S-NSSAI 1 for the NSSAA procedure has been ever authenticated and authorized successfully in the PLMN with NSSAA procedure and the UE 3 receives information related to S-NSSAI 1 during the current NSSAA procedure (e.g., the UE 3 receives S-NSSAI 1 during the current NSSAA procedure), the UE 3 may determine that the current NSSAA procedure as the Network Slice-Specific Authentication and Authorization procedure for S-NSSAI 1. In this case, the UE 3 may remove S-NSSAI 1 from the Allowed NSSAI, and store S-NSSAI 1 in the Pending NSSAI in the UE 3. In addition, the UE 3 may initiate the PDU Session Release procedure for those of the PDU Session(s) related to the S-NSSAI 1, if the PDU session(s) related to the S-NSSAI 1 is established.

For example, in a case where the UE 3 receives the Allowed NSSAI including S-NSSAI 1 during the UE configuration update procedure in a first NSSAA procedure for S-NSSAI 1 in step 0, the UE 3 may store information indicating that S-NSSAI 1 for the NSSAA procedure has been ever authenticated and authorized successfully in the PLMN with NSSAA procedure.

After the first NSSAA procedure, the second NSSAA procedure for S-NSSAI 1 is performed in step 3.

In this case, in a case where the UE 3 receives S-NSSAI 1 during the second NSSAA procedure, the UE 3 may determine whether the second NSSAA procedure is either the Network Slice-Specific Authentication and Authorization procedure or the Network Slice-Specific Re-authentication and Re-authorization procedure (e.g., the UE 3 may determine whether the NSSAI procedure for S-NSSAI 1 is for the first time).

In this case, as the UE 3 has the information indicating that S-NSSAI 1 for the NSSAA procedure has been ever authenticated and authorized successfully in the PLMN with NSSAA procedure, the UE 3 may determine that the second NSSAA procedure is the Network Slice-Specific Re-authentication and Re-authorization procedure (e.g., the UE 3 may determine that the NSSAA procedure for S-NSSAI 1 is reinitiated or restarted or reperformed or performed again, or the UE 3 may determine that the NSSAA procedure for S-NSSAI 1 is not the NSSAA procedure for S-NSSAI 1 for the first time). Then the UE 3 may keep S-NSSAI 1 in the Allowed NSSAI.

In a case where the UE 3 does not have the information indicating that the S-NSSAI for the NSSAA procedure has been ever authenticated and authorized successfully in the PLMN with NSSAA procedure, the UE 3 may determine that the second NSSAA procedure is the Network Slice-Specific Authentication and Authorization procedure (e.g., the UE 3 may determine that the second NSSAA procedure for S-NSSAI 1 is the NSSAA procedure for S-NSSAI 1 for the first time).

Then, the UE 3 may remove S-NSSAI 1 from the Allowed NSSAI and store S-NSSAI 1 to the Pending NSSAI in the UE 3. The UE 3 may initiate the PDU Session Release procedure for those of the PDU Session(s) related to S-NSSAI 1, if there is the PDU Session(s) related to S-NSSAI 1.

### Variant 4 of Second Example of the First Aspect

When the UE 3 is involved in the Network Slice-Specific Authentication and Authorization (NSSAA) procedure with a S-NSSAI in step 3 (e.g., in a case where the NSSAA procedure for the S-NSSAI is ongoing), the UE 3 may initiate the PDU Session Release procedure as described in the section 4.3.4 in 3GPP TS 23.502[3] for all PDU session(s) related to the S-NSSAI.

For example, in a case where the UE 3 receives the S-NSSAI during the NSSAA procedure, the UE 3 may initiate the PDU Session Release procedure for all PDU session(s) related to the S-NSSAI.

### Variant 5 of Second Example of the First Aspect

The first example, the second example and their variants are also applicable for a case when a mapping of S-NSSAI(s) in Allowed NSSAI to Subscribed NSSAI (e.g., S-NSSAI(s) in the Subscribed NSSAI) changes, the new mapped Subscribed NSSAI is not subject to NSSAA and the Configured NSSAI with respect to the new mapping or new Allowed NSSAI with respect to the new mapping is yet not delivered to the UE3 in the Configuration Update Command message during generic UE Configuration update procedure or in a Registration Accept message during the registration procedure. For example, in a case where the mapping between the assigned S-NSSAI (e.g., S-NSSAI(s) in the Allowed NSSAI or S-NSSAI(s) in the Subscribed NSSAI or S-NSSAI(s) in the Configured NSSAI) and the Subscribed NSSAI (e.g., S-NSSAI(s) in the Subscribed NSSAI) changes and the new mapped Subscribed NSSAI (e.g., the new mapped S-NSSAI(s) in the Subscribed NSSAI) is not subject to NSSAA, the AMF 70 may send, to the UE 3, at least one of the Configured NSSAI with respect to the new mapping (e.g., S-NSSAI(s) in the Configured NSSAI mapped to the S-NSSAI(s) in the new mapped Subscribed NSSAI), the new Allowed NSSAI with respect to the new mapping (e.g., S-NSSAI(s) in the Allowed NSSAI mapped to the S-NSSAI(s) in the new mapped Subscribed NSSAI) and the new mapped Subscribed NSSAI by using the Configuration Update Command message during generic UE Configuration update procedure or the Registration Accept message during the registration procedure.

### System Overview

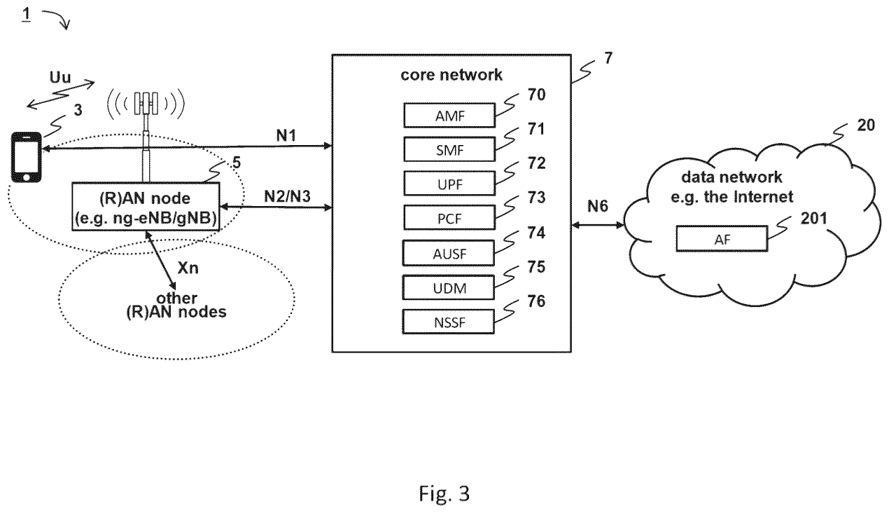

FIG. 3 schematically illustrates a telecommunication system 1 for a mobile (cellular or wireless) to which the above aspects are applicable.

The telecommunication system I represents a system overview in which an end to end communication is possible. For example, UE 3 (or user equipment, ‘mobile device’ 3) communicates with other UEs 3 or service servers in the data network via respective (R)AN nodes 5 and a core network 7.

The (R)AN node 5 supports any radio accesses including a 5G radio access technology (RAT), an E-UTRA radio access technology, a beyond 5G RAT, a 6G RAT and non-3GPP RAT including wireless local area network (WLAN) technology as defined by the Institute of Electrical and Electronics Engineers (IEEE).

The (R)AN node 5 may split into a Radio Unit (RU), Distributed Unit (DU) and Centralized Unit (CU). In some aspects, each of the units may be connected to each other and structure the (R)AN node 5 by adopting an architecture as defined by the Open RAN (O-RAN) Alliance, where the units above are referred to as O-RU, O-DU and O-CU respectively.

The (R)AN node 5 may be split into control plane function and user plane function. Further, multiple user plane functions can be allocated to support a communication. In some aspects, user traffic may be distributed to multiple user plane functions and user traffic over each user plane functions are aggregated in both the UE 3 and the (R)AN node 5. This split architecture may be called as ‘dual connectivity’ or ‘Multi connectivity’.

The (R)AN node 5 can also support a communication using the satellite access. In some aspects, the (R)AN node 5 may support a satellite access and a terrestrial access.

In addition, the (R)AN node 5 can also be referred as an access node for a non-wireless access. The non-wireless access includes a fixed line access as defined by the Broadband Forum (BBF) and an optical access as defined by the Innovative Optical and Wireless Network (IOWN).

The core network 7 may include logical nodes (or ‘functions’) for supporting a communication in the telecommunication system 1. For example, the core network 7 may be 5G Core Network (5GC) that includes, amongst other functions, control plane functions and user plane functions. Each function in a logical node can be considered as a network function. The network function may be provided to another node by adapting the Service Based Architecture (SBA).

A Network Function can be deployed as distributed, redundant, stateless, and scalable that provides the services from several locations and several execution instances in each location by adapting the network virtualization technology as defined by the European Telecommunications Standards Institute, Network Functions Virtualization (ETSI NFV).

The core network 7 may support the Non-Public Network (NPN). The NPN may be a Stand-alone Non-Public Network (SNPN) or a Public Network Integrated NPN (PNI-NPN).

As is well known, a UE 3 may enter and leave the areas (i.e. radio cells) served by the (R)AN node 5 as the UE 3 is moving around in the geographical area covered by the telecommunication system 1. In order to keep track of the UE 3 and to facilitate movement between the different (R)AN nodes 5, the core network 7 comprises at least one access and mobility management function (AMF) 70. The AMF 70 is in communication with the (R)AN node 5 coupled to the core network 7. In some core networks, a mobility management entity (MME) or a mobility management node for beyond 5G or a mobility management node for 6G may be used instead of the AMF 70.

The core network 7 also includes, amongst others, a Session Management Function (SMF) 71, a User Plane Function (UPF) 72, a Policy Control Function (PCF) 73, an Authentication Server Function (AUSF) 74, a Unified Data Management (UDM) 75, and a Network Slice-Specific Authentication and Authorization Function (NSSAAF) 76. When the UE 3 is roaming to a visited Public Land Mobile Network (VPLMN), a home Public Land Mobile Network (HPLMN) of the UE 3 provides the UDM 75 and at least some of the functionalities of the SMF 71, UPF 72, and PCF 73 for the roaming-out UE 3.

The UE 3 and a respective serving (R)AN node 5 are connected via an appropriate air interface (for example the so-called “Uu” interface and/or the like). Neighboring (R)AN node 5 are connected to each other via an appropriate (R)AN node 5 to (R)AN node interface (such as the so-called “Xn” interface and/or the like). Each (R)AN node 5 is also connected to nodes in the core network 7 (such as the so-called core network nodes) via an appropriate interface (such as the so-called “N2”/“N3” interface(s) and/or the like). From the core network 7, connection to a data network 20 is also provided. The data network 20 can be an internet, a public network, an external network, a private network or an internal network of the PLMN. In case that the data network 20 is provided by a PLMN operator or Mobile Virtual Network Operator (MVNO), the IP Multimedia Subsystem (IMS) service may be provided by that data network 20. The UE 3 can be connected to the data network 20 using IPv4, IPv6, IPv4v6, Ethernet or unstructured data type.

The “Uu” interface may include a Control plane of Uu interface and User plane of Uu interface.

The User plane of Uu interface is responsible to convey user traffic between the UE 3 and a serving (R)AN node 5. The User plane of Uu interface may have a layered structure with SDAP, PDCP, RLC and MAC sublayer over the physical connection.

The Control plane of Uu interface is responsible to establish, modify and release a connection between the UE 3 and a serving (R)AN node 5. The Control plane of Uu interface may have a layered structure with RRC, PDCP, RLC and MAC sublayers over the physical connection.

For example, the following messages are communicated over the RRC layer to support AS signaling.
RRC Setup Request message: This message is sent from the UE 3 to the (R)AN node 5. In addition to the parameters that are disclosed by Aspects in this disclosure, following parameters may be included together in the RRC Setup Request message.
   establishmentCause and ue-Identity. The ue-Identity may have a value of ng-5G-S-TMSI-Part1 or random Value.
RRC Setup message: This message is sent from the (R)AN node 5 to the UE 3. In addition to the parameters that are disclosed by Aspects in this disclosure, following parameters may be included together in the RRC Setup message.
   masterCellGroup and radioBearerConfig
RRC setup complete message: This message is sent from the UE 3 to the (R)AN node 5. In addition to the parameters that are disclosed by Aspects in this disclosure, following parameters may be included together in the RRC setup complete message.
   guami-Type, iab-NodeIndication, idleMeasAvailable, mobilityState, ng-5G-S-TMSI-Part2, registeredAMF, selectedPLMN-Identity

The UE 3 and the AMF 70 are connected via an appropriate interface (for example the so-called N1 interface and/or the like). The N1 interface is responsible to provide a communication between the UE 3 and the AMF 70 to support NAS signaling. The N1 interface may be established over a 3GPP access and over a non-3GPP access. For example, the following messages are communicated over the N1 interface.
registration request message: This message is sent from the UE 3 to the AMF 70. In addition to the parameters that are disclosed by Aspects in this disclosure, following parameters may be included together in the registration request message.
   5GS registration type, ngKSI, 5GS mobile identity, Non-current native NAS key set identifier, 5GMM capability, UE security capability, Requested NSSAI, Last visited registered TAI, SI UE network capability, Uplink data status, PDU session status, MICO indication, UE status, Additional GUTI, Allowed PDU session status, UE's usage setting, Requested DRX parameters, EPS NAS message container, LADN indication, Payload container type, Payload container, Network slicing indication, 5GS update type, Mobile station classmark 2, Supported codecs, NAS message container, EPS bearer context status, Requested extended DRX parameters, T3324 value, UE radio capability ID, Requested mapped NSSAI, Additional information requested, Requested WUS assistance information, N5GC indication and Requested NB-N1 mode DRX parameters.
registration accept message: This message is sent from the AMF 70 to the UE 3. In addition to the parameters that are disclosed by Aspects in this disclosure, following parameters may be included together in the registration accept message.
   5GS registration result, 5G-GUTI, Equivalent PLMNs, TAI list, Allowed NSSAI, Rejected NSSAI, Configured NSSAI, 5GS network feature support, PDU session status, PDU session reactivation result, PDU session reactivation result error cause, LADN information, MICO indication, Network slicing indication, Service area list, T3512 value, Non-3GPP de-registration timer value, T3502 value, Emergency number list, Extended emergency number list, SOR transparent container, EAP message, NSSAI inclusion mode, Operator-defined access category definitions, Negotiated DRX parameters, Non-3GPP NW policies, EPS bearer context status, Negotiated extended DRX parameters, T3447 value, T3448 value, T3324 value, UE radio capability ID, UE radio capability ID deletion indication, Pending NSSAI, Ciphering key data, CAG information list, Truncated 5G-S-TMSI configuration, Negotiated WUS assistance information, Negotiated NB-N1 mode DRX parameters and Extended rejected NSSAI.
Registration Complete message: This message is sent from the UE 3 to the AMF 70. In addition to the parameters that are disclosed by Aspects in this disclosure, following parameters may be included together in the Registration Complete message.
   SOR transparent container.
Authentication Request message: This message is sent from the AMF 70 to the UE 3. In addition to the parameters that are disclosed by Aspects in this disclosure, following parameters may be included together in the Authentication Request message.
   ngKSI, ABBA, Authentication parameter RAND (5G authentication challenge), Authentication parameter AUTN (5G authentication challenge) and EAP message.
Authentication Response message: This message is sent from the UE 3 to the AMF 70. In addition to the parameters that are disclosed by Aspects in this disclosure, following parameters may be populated together in the Authentication Response message.
   Authentication response message identity, Authentication response parameter and EAP message.
Authentication Result message: This message is sent from the AMF 70 to the UE 3. In addition to the parameters that are disclosed by Aspects in this disclosure, following parameters may be populated together in the Authentication Result message.
   ngKSI, EAP message and ABBA.
Authentication Failure message: This message is sent from the UE 3 to the AMF 70. In addition to the parameters that are disclosed by Aspects in this disclosure, following parameters may be populated together in the Authentication Failure message.
   Authentication failure message identity, 5GMM cause and Authentication failure parameter.
Authentication Reject message: This message is sent from the AMF 70 to the UE 3. In addition to the parameters that are disclosed by Aspects in this disclosure, following parameters may be populated together in the Authentication Reject message.
   EAP message.
Service Request message: This message is sent from the UE 3 to the AMF 70. In addition to the parameters that are disclosed by Aspects in this disclosure, following parameters may be populated together in the Service Request message.
   ngKSI, Service type, 5G-S-TMSI, Uplink data status, PDU session status, Allowed PDU session status, NAS message container.
Service Accept message: This message is sent from the AMF 70 to the UE 3. In addition to the parameters that are disclosed by Aspects in this disclosure, following parameters may be populated together in the Service Accept message.
   PDU session status, PDU session reactivation result, PDU session reactivation result error cause, EAP message and T3448 value.
Service Reject message: This message is sent from the AMF 70 to the UE 3. In addition to the parameters that are disclosed by Aspects in this disclosure, following parameters may be populated together in the Service Reject message.
   5GMM cause, PDU session status, T3346 value, EAP message, T3448 value and CAG information list.
Configuration Update Command message: This message is sent from the AMF 70 to the UE 3. In addition to the parameters that are disclosed by Aspects in this disclosure, following parameters may be populated together in the Configuration Update Command message.
   Configuration update indication, 5G-GUTI, TAI list, Allowed NSSAI, Service area list, Full name for network, Short name for network, Local time zone, Universal time and local time zone, Network daylight saving time, LADN information, MICO indication, Network slicing indication, Configured NSSAI, Rejected NSSAI, Operator-defined access category definitions, SMS indication, T3447 value, CAG information list, UE radio capability ID, UE radio capability ID deletion indication, 5GS registration result, Truncated 5G-S-TMSI configuration, Additional configuration indication and Extended rejected NSSAI.
Configuration Update Complete message: This message is sent from the UE 3 to the AMF 70. In addition to the parameters that are disclosed by Aspects in this disclosure, following parameters may be populated together in the Configuration Update Complete message.
   Configuration update complete message identity.

### User Equipment (UE)

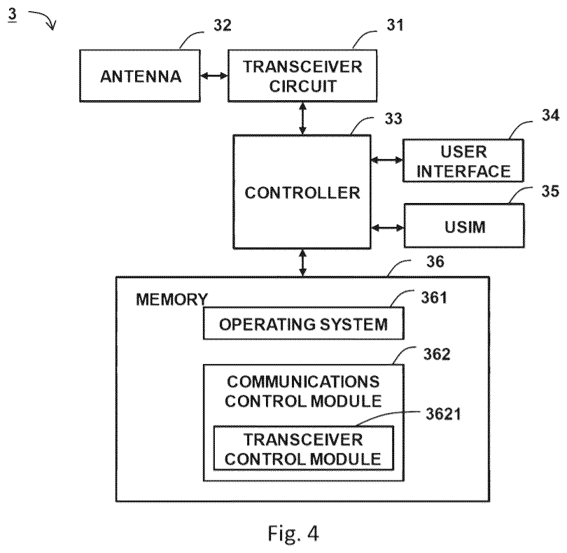

FIG. 4 is a block diagram illustrating the main components of the UE 3 (mobile device 3). As shown, the UE 3 includes a transceiver circuit 31 which is operable to transmit signals to and to receive signals from the connected node(s) via one or more antennas 32. Further, the UE 3 may include a user interface 34 for inputting information from outside or outputting information to outside. Although not necessarily shown in the Figure, the UE 3 may have all the usual functionality of a conventional mobile device and this may be provided by any one or any combination of hardware, software and firmware, as appropriate. Software may be pre-installed in the memory and/or may be downloaded via the telecommunication network or from a removable data storage device (RMD), for example. A controller 33 controls the operation of the UE 3 in accordance with software stored in a memory 36. The software includes, among other things, an operating system 361 and a communications control module 362 having at least a transceiver control module 3621. The communications control module 362 (using its transceiver control module 3621) is responsible for handling (generating/sending/receiving) signalling and uplink/downlink data packets between the UE 3 and other nodes, such as the (R)AN node 5 and the AMF 70. Such signalling may include, for example, appropriately formatted signalling messages (e.g. a registration request message and associated response messages) relating to access and mobility management procedures (for the UE 3). The controller 33 interworks with one or more Universal Subscriber Identity Module (USIM) 35. If there are multiple USIMs 35 equipped, the controller 33 may activate only one USIM 35 or may activate multiple USIMs 35 at the same time.

The UE 3 may, for example, support the Non-Public Network (NPN), The NPN may be a Stand-alone Non-Public Network (SNPN) or a Public Network Integrated NPN (PNI-NPN).

The UE 3 may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

The UE 3 may, for example, be an item of transport equipment (for example transport equipment such as: rolling stocks: motor vehicles; motor cycles; bicycles; trains; buses; carts; rickshaws: ships and other watercraft: aircraft; rockets: satellites; drones; balloons etc.).

The UE 3 may, for example, be an item of information and communication equipment (for example information and communication equipment such as: electronic computer and related equipment; communication and related equipment; electronic components etc.).

The UE 3 may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio: a television; a microwave oven; a rice cooker: a coffee machine; a dishwasher: a washing machine: a dryer: an electronic fan or related appliance: a cleaner etc.).

The UE 3 may, for example, be an electrical application system or equipment (for example an electrical application system or equipment such as: an x-ray system: a particle accelerator; radio isotope equipment; sonic equipment; electromagnetic application equipment; electronic power application equipment etc.).

The UE 3 may, for example, be an electronic lamp, a luminaire, a measuring instrument, an analyzer, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

The UE 3 may, for example, be a wireless-equipped personal digital assistant or related equipment (such as a wireless card or module designed for attachment to or for insertion into another electronic device (for example a personal computer, electrical measuring machine)).

The UE 3 may be a device or a part of a system that provides applications, services, and solutions described below, as to “internet of things (IoT)”, using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices or Narrow Band-IoT UE (NB-IoT UE). It will be appreciated that a UE 3 may support one or more IoT or MTC applications.

The UE 3 may be a smart phone or a wearable device (e.g. smart glasses, a smart watch, a smart ring, or a hearable device).

The UE 3 may be a car, or a connected car, or an autonomous car, or a vehicle device, or a motorcycle or V2X (Vehicle to Everything) communication module (e.g. Vehicle to Vehicle communication module, Vehicle to Infrastructure communication module, Vehicle to People communication module and Vehicle to Network communication module).

### (R)AN Node

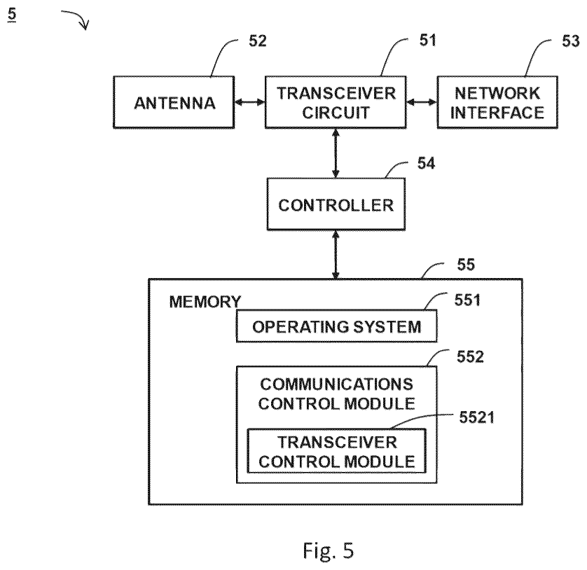

FIG. 5 is a block diagram illustrating the main components of an exemplary (R)AN node 5, for example a base station (′eNB′ in LTE, ‘gNB’ in 5G, a base station for 5G beyond, a base station for 6G). As shown, the (R)AN node 5 includes a transceiver circuit 51 which is operable to transmit signals to and to receive signals from connected UE(s) 3 via one or more antennas 52 and to transmit signals to and to receive signals from other network nodes (either directly or indirectly) via a network interface 53. A controller 54 controls the operation of the (R)AN node 5 in accordance with software stored in a memory 55. Software may be pre-installed in the memory and/or may be downloaded via the telecommunication network or from a removable data storage device (RMD), for example. The software includes, among other things, an operating system 551 and a communications control module 552 having at least a transceiver control module 5521.

The communications control module 552 (using its transceiver control sub-module) is responsible for handling (generating/sending/receiving) signalling between the (R)AN node 5 and other nodes, such as the UE 3, another (R)AN node 5, the AMF 70 and the UPF 72 (e.g. directly or indirectly). The signalling may include, for example, appropriately formatted signalling messages relating to a radio connection and a connection with the core network 7 (for a particular UE 3), and in particular, relating to connection establishment and maintenance (e.g. RRC connection establishment and other RRC messages), NG Application Protocol (NGAP) messages (i.e. messages by N2 reference point) and Xn application protocol (XnAP) messages (i.e. messages by Xn reference point), etc. Such signalling may also include, for example, broadcast information (e.g. Master Information and System information) in a sending case.

The controller 54 is also configured (by software or hardware) to handle related tasks such as, when implemented, UE mobility estimate and/or moving trajectory estimation.

The (R)AN node 5 may support the Non-Public Network (NPN). The NPN may be a Stand-alone Non-Public Network (SNPN) or a Public Network Integrated NPN (PNI-NPN).

### System Overview of (R)AN Node 5 Based on O-RAN Architecture

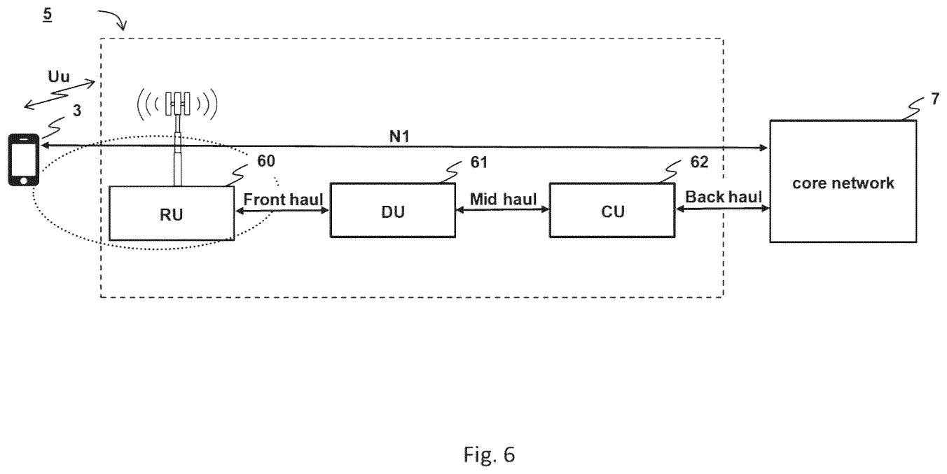

FIG. 6 schematically illustrates a (R)AN node 5 based on O-RAN architecture to which the (R)AN node 5 aspects are applicable.

The (R)AN node 5 based on O-RAN architecture represents a system overview in which the (R)AN node is split into a Radio Unit (RU) 60, Distributed Unit (DU) 61 and Centralized Unit (CU) 62. In some aspects, each unit may be combined. For example, the RU 60 can be integrated/combined with the DU 61 as an integrated/combined unit, the DU 61 can be integrated/combined with the CU 62 as another integrated/combined unit. Any functionality in the description for a unit (e.g. one of RU 60, DU 61 and CU 62) can be implemented in the integrated/combined unit above. Further, CU 62 can separate into two functional units such as CU Control plane (CP) and CU User plane (UP). The CU CP has a control plane functionality in the (R)AN node 5. The CU UP has a user plane functionality in the (R)AN node 5. Each CU CP is connected to the CU UP via an appropriate interface (such as the so-called “E1” interface and/or the like).

The UE 3 and a respective serving RU 60 are connected via an appropriate air interface (for example the so-called “Uu” interface and/or the like). Each RU 60 is connected to the DU 61 via an appropriate interface (such as the so-called “Front haul”, “Open Front haul”, “F1” interface and/or the like). Each DU 61 is connected to the CU 62 via an appropriate interface (such as the so-called “Mid haul”, “Open Mid haul”, “E2” interface and/or the like). Each CU 62 is also connected to nodes in the core network 7 (such as the so-called core network nodes) via an appropriate interface (such as the so-called “Back haul”, “Open Back haul”, “N2”/“N3” interface(s) and/or the like). In addition, a user plane part of the DU 61 can also be connected to the core network 7 via an appropriate interface (such as the so-called “N3” interface(s) and/or the like).

Depending on functionality split among the RU 60, DU 61 and CU 62, each unit provides some of the functionality that is provided by the (R)AN node 5. For example, the RU 60 may provide a functionalities to communicate with a UE 3 over air interface, the DU 61 may provide functionalities to support MAC layer and RLC layer, the CU 62 may provide functionalities to support PDCP layer, SDAP layer and RRC layer.

### Radio Unit (RU)

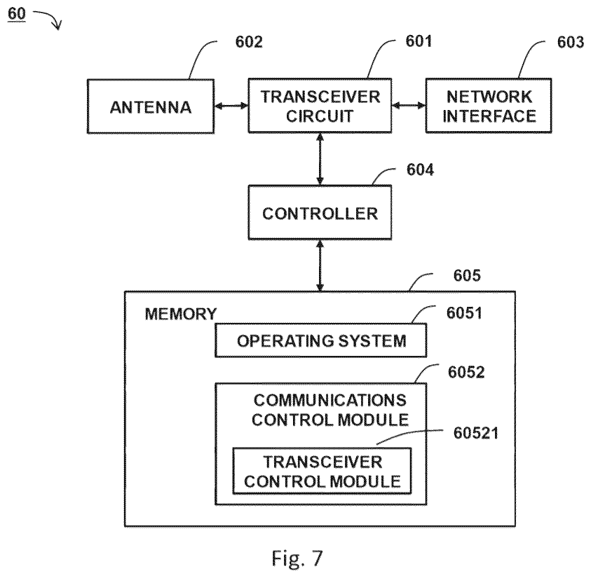

FIG. 7 is a block diagram illustrating the main components of an exemplary RU 60, for example a RU part of base station (′eNB′ in LTE, ‘gNB’ in 5G, a base station for 5G beyond, a base station for 6G). As shown, the RU 60 includes a transceiver circuit 601 which is operable to transmit signals to and to receive signals from connected UE(s) 3 via one or more antennas 602 and to transmit signals to and to receive signals from other network nodes or network unit (either directly or indirectly) via a network interface 603. A controller 604 controls the operation of the RU 60 in accordance with software stored in a memory 605. Software may be pre-installed in the memory and/or may be downloaded via the telecommunication network or from a removable data storage device (RMD), for example. The software includes, among other things, an operating system 6051 and a communications control module 6052 having at least a transceiver control module 60521.

The communications control module 6052 (using its transceiver control sub-module) is responsible for handling (generating/sending/receiving) signalling between the RU 60 and other nodes or units, such as the UE 3, another RU 60 and DU 61 (e.g. directly or indirectly). The signalling may include, for example, appropriately formatted signalling messages relating to a radio connection and a connection with the RU 60 (for a particular UE 3), and in particular, relating to MAC layer and RLC layer.

The controller 604 is also configured (by software or hardware) to handle related tasks such as, when implemented, UE mobility estimate and/or moving trajectory estimation.

The RU 60 may support the Non-Public Network (NPN). The NPN may be a Stand-alone Non-Public Network (SNPN) or a Public Network Integrated NPN (PNI-NPN).

As described above, the RU 60 can be integrated/combined with the DU 61 as an integrated/combined unit. Any functionality in the description for the RU 60 can be implemented in the integrated/combined unit above.

### Distributed Unit (DU)

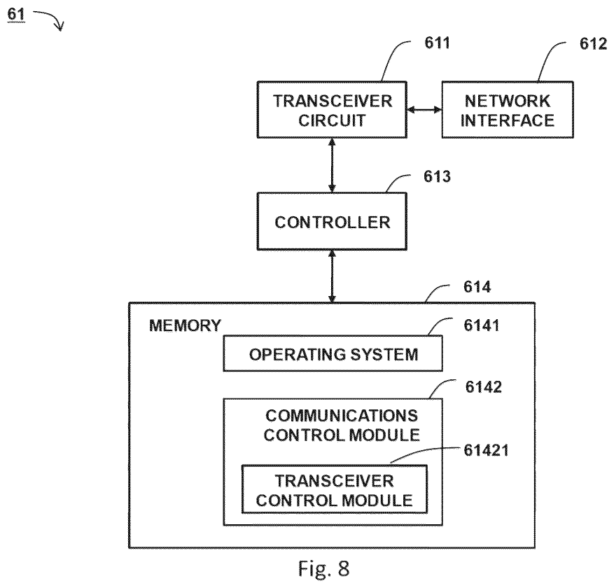

FIG. 8 is a block diagram illustrating the main components of an exemplary DU 61, for example a DU part of a base station (′eNB′ in LTE, ‘gNB’ in 5G, a base station for 5G beyond, a base station for 6G). As shown, the apparatus includes a transceiver circuit 611 which is operable to transmit signals to and to receive signals from other nodes or units (including the RU 60) via a network interface 612. A controller 613 controls the operation of the DU 61 in accordance with software stored in a memory 614. Software may be pre-installed in the memory 614 and/or may be downloaded via the telecommunication network or from a removable data storage device (RMD), for example. The software includes, among other things, an operating system 6141 and a communications control module 6142 having at least a transceiver control module 61421. The communications control module 6142 (using its transceiver control module 61421 is responsible for handling (generating/sending/receiving) signalling between the DU 61 and other nodes or units, such as the RU 60 and other nodes and units.

The DU 61 may support the Non-Public Network (NPN). The NPN may be a Stand-alone Non-Public Network (SNPN) or a Public Network Integrated NPN (PNI-NPN).

As described above, the RU 60 can be integrated/combined with the DU 61 or CU 62 as an integrated/combined unit. Any functionality in the description for DU 61 can be implemented in one of the integrated/combined unit above.

### Centralized Unit (CU)

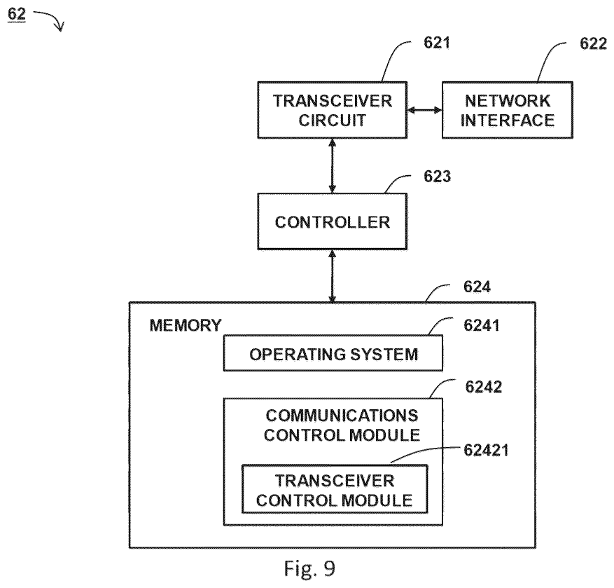

FIG. 9 is a block diagram illustrating the main components of an exemplary CU 62, for example a CU part of base station (′eNB′ in LTE, ‘gNB’ in 5G, a base station for 5G beyond, a base station for 6G). As shown, the apparatus includes a transceiver circuit 621 which is operable to transmit signals to and to receive signals from other nodes or units (including the DU 61) via a network interface 622. A controller 623 controls the operation of the CU 62 in accordance with software stored in a memory 624. Software may be pre-installed in the memory 624 and/or may be downloaded via the telecommunication network or from a removable data storage device (RMD), for example. The software includes, among other things, an operating system 6241 and a communications control module 6242 having at least a transceiver control module 62421. The communications control module 6242 (using its transceiver control module 62421 is responsible for handling (generating/sending/receiving) signalling between the CU 62 and other nodes or units, such as the DU 61 and other nodes and units.

The CU 62 may support the Non-Public Network (NPN). The NPN may be a Stand-alone Non-Public Network (SNPN) or a Public Network Integrated NPN (PNI-NPN).

As described above, the CU 62 can be integrated/combined with the DU 61 as an integrated/combined unit. Any functionality in the description for the CU 62 can be implemented in the integrated/combined unit above. AMF

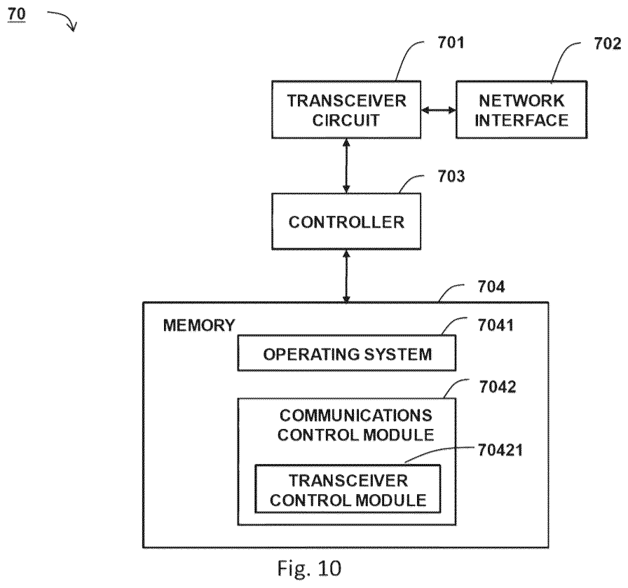

FIG. 10 is a block diagram illustrating the main components of the AMF 70. As shown, the apparatus includes a transceiver circuit 701 which is operable to transmit signals to and to receive signals from other nodes (including the UE 3, NSSAAF) via a network interface 702. A controller 703 controls the operation of the AMF 70 in accordance with software stored in a memory 704. Software may be pre-installed in the memory 704 and/or may be downloaded via the telecommunication network or from a removable data storage device (RMD), for example. The software includes, among other things, an operating system 7041 and a communications control module 7042 having at least a transceiver control module 70421. The communications control module 7042 (using its transceiver control module 70421 is responsible for handling (generating/sending/receiving) signalling between the AMF 70 and other nodes, such as the UE 3 (e.g. via the (R)AN node 5) and other core network nodes (including core network nodes in the HPLMN of the UE 3 when the UE 3 is roaming-in. Such signalling may include, for example, appropriately formatted signalling messages (e.g. a registration request message and associated response messages) relating to access and mobility management procedures (for the UE 3).

The AMF 70 may support the Non-Public Network (NPN). The NPN may be a Stand-alone Non-Public Network (SNPN) or a Public Network Integrated NPN (PNI-NPN). An AMF 7001 and an AMF 7002 may have same components to the AMF 70.

### PCF

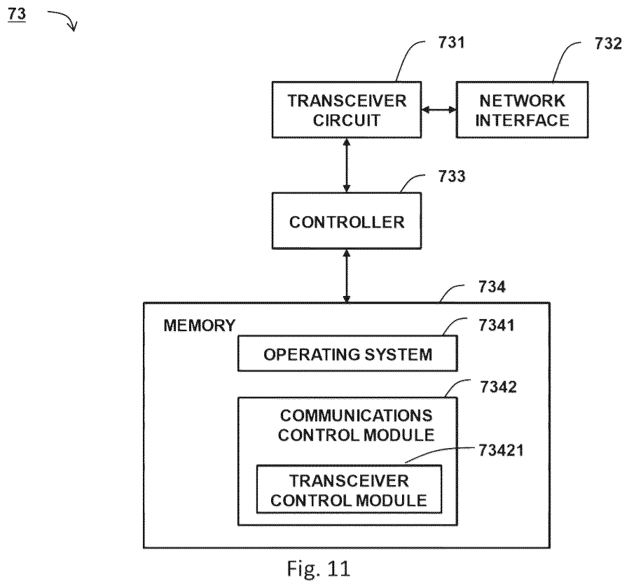

FIG. 11 is a block diagram illustrating the main components of the PCF 73. As shown, the apparatus includes a transceiver circuit 731 which is operable to transmit signals to and to receive signals from other nodes (including the AMF 70) via a network interface 732. A controller 733 controls the operation of the PCF 73 in accordance with software stored in a memory 734. Software may be pre-installed in the memory 734 and/or may be downloaded via the telecommunication network or from a removable data storage device (e.g. a removable memory device (RMD)), for example. The software includes, among other things, an operating system 7341 and a communications control module 7342 having at least a transceiver control module 73421. The communications control module 7342 (using its transceiver control module 73421 is responsible for handling (generating/sending/receiving) signalling between the PCF 73 and other nodes, such as the AMF 70 and other core network nodes (including core network nodes in the HPLMN of the UE 3 when the UE 3 is roaming-in. Such signalling may include, for example, appropriately formatted signalling messages (e.g. a HTTP restful methods based on the service based interfaces) relating to policy management procedures (for the UE 3).

The PCF 73 may support the Non-Public Network (NPN). The NPN may be a Stand-alone Non-Public Network (SNPN) or a Public Network Integrated NPN (PNI-NPN). A PCF 7301 and a PCF 7302 may have same components to the PCF 73.

### AUSF

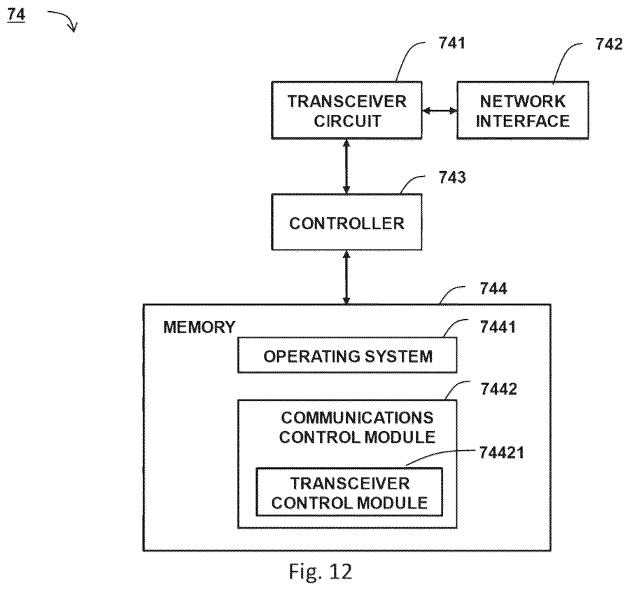

FIG. 12 is a block diagram illustrating the main components of the AUSF 74. As shown, the apparatus includes a transceiver circuit 741 which is operable to transmit signals to and to receive signals from other nodes (including the UDM 75) via a network interface 742. A controller 743 controls the operation of the AUSF 74 in accordance with software stored in a memory 744. Software may be pre-installed in the memory 744 and/or may be downloaded via the telecommunication network or from a removable data storage device (e.g. a removable memory device (RMD)), for example. The software includes, among other things, an operating system 7441 and a communications control module 7442 having at least a transceiver control module 74421. The communications control module 7442 (using its transceiver control module 74421 is responsible for handling (generating/sending/receiving) signalling between the AUSF 74 and other nodes, such as the AMF 70 and other core network nodes (including core network nodes in the HPLMN of the UE 3 when the UE 3 is roaming-in. Such signalling may include, for example, appropriately formatted signalling messages (e.g. a HTTP restful methods based on the service based interfaces) relating to policy management procedures (for the UE 3).

The AUSF 74 may support the Non-Public Network (NPN). The NPN may be a Stand-alone Non-Public Network (SNPN) or a Public Network Integrated NPN (PNI-NPN).

### UDM

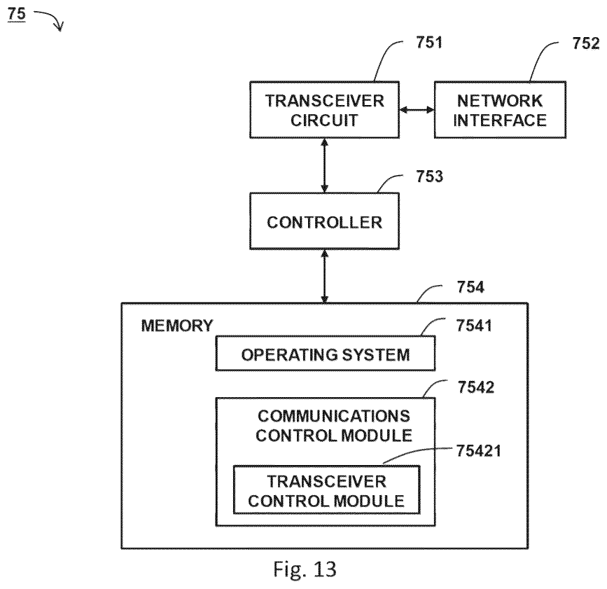

FIG. 13 is a block diagram illustrating the main components of the UDM 75. As shown, the apparatus includes a transceiver circuit 751 which is operable to transmit signals to and to receive signals from other nodes (including the AMF 70) via a network interface 752. A controller 753 controls the operation of the UDM 75 in accordance with software stored in a memory 754. Software may be pre-installed in the memory 754 and/or may be downloaded via the telecommunication network or from a removable data storage device (RMD), for example. The software includes, among other things, an operating system 7541 and a communications control module 7542 having at least a transceiver control module 75421. The communications control module 7542 (using its transceiver control module 75421 is responsible for handling (generating/sending/receiving) signalling between the UDM 75 and other nodes, such as the AMF 70 and other core network nodes (including core network nodes in the VPLMN of the UE 3 when the UE 3 is roaming-out. Such signalling may include, for example, appropriately formatted signalling messages (e.g. a HTTP restful methods based on the service based interfaces) relating to mobility management procedures (for the UE 3).

The UDM 75 may support the Non-Public Network (NPN). The NPN may be a Stand-alone Non-Public Network (SNPN) or a Public Network Integrated NPN (PNI-NPN).

### NSSF

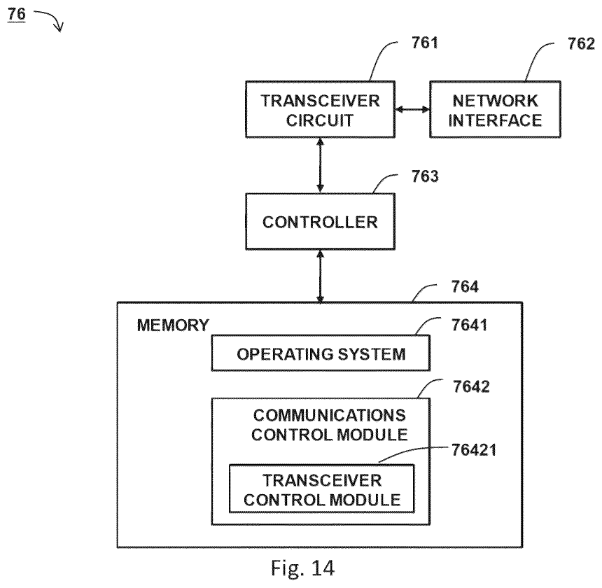

FIG. 14 is a block diagram illustrating the main components of the NSSF 76. As shown, the apparatus includes a transceiver circuit 761 which is operable to transmit signals to and to receive signals from other nodes (including the AMF 70) via a network interface 762. A controller 763 controls the operation of the NSSF 76 in accordance with software stored in a memory 764. Software may be pre-installed in the memory 764 and/or may be downloaded via the telecommunication network or from a removable data storage device (RMD), for example. The software includes, among other things, an operating system 7641 and a communications control module 7642 having at least a transceiver control module 76421. The communications control module 7642 (using its transceiver control module 76421 is responsible for handling (generating/sending/receiving) signalling between the NSSF 76 and other nodes, such as the AMF 70 and other core network nodes (including core network nodes in the VPLMN of the UE 3 when the UE 3 is roaming-out. Such signalling may include, for example, appropriately formatted signalling messages (e.g. a HTTP restful methods based on the service based interfaces) relating to mobility management procedures (for the UE 3).

The NSSF 76 may support the Non-Public Network (NPN). The NPN may be a Stand-alone Non-Public Network (SNPN) or a Public Network Integrated NPN (PNI-NPN).

The whole or part of the example Aspects disclosed above can be described as, but not limited to, the following.

5.15.5.2 Selection of a Serving AMF supporting the Network Slices

### 5.15.5.2.1 Registration to a set of Network Slices

When a UE registers over an Access Type with a PLMN, if the UE has either or both of;
a Configured NSSAI for this PLMN;
an Allowed NSSAI for this PLMN and Access Type;
   the UE shall provide to the network, in AS layer under the conditions described in clause 5.15.9 and in NAS layer, a Requested NSSAI containing the S-NSSAI(s) corresponding to the Network Slice(s) to which the UE wishes to register, unless they are stored in the UE in the Pending NSSAI.

The Requested NSSAI shall be one of;
the Default Configured NSSAI, i.e. if the UE has no Configured NSSAI nor an Allowed NSSAI for the serving PLMN;
the Configured-NSSAI, or a subset thereof as described below, e.g. if the UE has no Allowed NSSAI for the Access Type for the serving PLMN;
the Allowed-NSSAI for the Access Type over which the Requested NSSAI is sent, or a subset thereof; or
the Allowed-NSSAI for the Access Type over which the Requested NSSAI is sent, or a subset thereof, plus one or more S-NSSAIs from the Configured-NSSAI not yet in the Allowed NSSAI for the Access Type as described below.

NOTE 1: If the UE wishes to register only a subset of the S-NSSAIs from the Configured NSSAI or the Allowed NSSAI, to be able to register with some Network Slices e.g. to establish PDU Sessions for some application(s), and the UE uses the URSP rules (which includes the NSSP) or the UE Local Configuration as defined in clause 6.1.2.2.1 of TS 23.503[45], then the UE uses applicable the URSP rules or the UE Local Configuration to ensure that the S-NSSAIs included in the Requested NSSAI are not in conflict with the URSP rules or with the UE Local Configuration.

The subset of S-NSSAIs in the Configured-NSSAI provided in the Requested NSSAI consists of one or more S-NSSAI(s) in the Configured NSSAI applicable to this PLMN, if one is present, and for which no corresponding S-NSSAI is already present in the Allowed NSSAI for the access type for this PLMN. The UE shall not include in the Requested NSSAI any S-NSSAI that is currently rejected by the network (i.e. rejected in the current registration area or rejected in the PLMN). For the registration to a PLMN for which neither a Configured NSSAI applicable to this PLMN or an Allowed NSSAI are present, the S-NSSAIs provided in the Requested NSSAI correspond to the S-NSSAI(s) in the Default Configured NSSAI unless the UE has HPLMN S-NSSAI for established PDU Session(s) in which case the HPLMN S-NSSAI(s) shall be provided in the mapping of Requested NSSAI in the NAS Registration Request message, with no corresponding VPLMN S-NSSAI in the Requested NSSAI. If the UE has been provided with NSSRG information together with the Configured NSSAI, the UE only includes in the Requested NSSAI S-NSSAIs that share a common NSSRG, see clause 5.15.12.2.

When a UE registers over an Access Type with a PLMN, the UE shall also indicate in the Registration Request message when the Requested NSSAI is based on the Default Configured NSSAI.

The UE shall include the Requested NSSAI in the RRC Connection Establishment and in the establishment of the connection to the N3IWF/TNGF (as applicable) and in the NAS Registration procedure messages subject to conditions set out in clause 5.15.9. However, the UE shall not indicate any NSSAI in RRC Connection Establishment or Initial NAS message unless it has either a Configured NSSAI for the corresponding PLMN, an Allowed NSSAI for the corresponding PLMN and Access Type, or the Default Configured NSSAI. If the UE has HPLMN S-NSSAI(s) for established PDU Session(s), the HPLMN S-NSSAI(s) shall be provided in the mapping of Requested NSSAI in the NAS Registration Request message, independent of whether the UE has the corresponding VPLMN S-NSSAI. The (R)AN shall route the NAS signalling between this UE and an AMF selected using the Requested NSSAI obtained during RRC Connection Establishment or connection to N3IWF/TNGF respectively. If the (R)AN is unable to select an AMF based on the Requested NSSAI, it routes the NAS signalling to an AMF from a set of default AMFs. In the NAS signalling, if available, the UE provides the mapping of each S-NSSAI of the Requested NSSAI to a corresponding HPLMN S-NSSAI.

When a UE registers with a PLMN, if for this PLMN the UE has not included a Requested NSSAI nor a GUAMI while establishing the connection to the (R)AN, the (R)AN shall route all NAS signalling from/to this UE to/from a default AMF. When receiving from the UE a Requested NSSAI and a 5G-S-TMSI or a GUAMI in RRC Connection Establishment or in the establishment of connection to N3IWF/TNGF, if the 5G-AN can reach an AMF corresponding to the 5G-S-TMSI or GUAMI, then 5G-AN forwards the request to this AMF. Otherwise, the 5G-AN selects a suitable AMF based on the Requested NSSAI provided by the UE and forwards the request to the selected AMF. If the 5G-AN is not able to select an AMF based on the Requested NSSAI, then the request is sent to a default AMF.

When the AMF selected by the AN during Registration Procedure receives the UE Registration request, or after an AMF selection by MME (i.e. during EPS to 5GS handover) the AMF receives S-NSSAI(s) from SMF+PGW-C in 5GC;
As part of the Registration procedure described in clause 4.2.2.2.2 of TS 23.502 [3], or as part of the EPS to 5GS handover using N26 interface procedure described in clause 4. 11. 1.2.2 of TS 23.502[3], the AMF may query the UDM to retrieve UE subscription information including the Subscribed S-NSSAIs.
The AMF verifies whether the S-NSSAI(s) in the Requested NSSAI or the S-NSSAI(s) received from SMF+PGW-C are permitted based on the Subscribed S-NSSAIs (to identify the Subscribed S-NSSAIs the AMF may use the mapping to HPLMN S-NSSAIs provided by the UE, in the NAS message, for each S-NSSAI of the Requested NSSAI).
When the UE context in the AMF does not yet include an Allowed NSSAI for the corresponding Access Type, the AMF queries the NSSF (see (B) below for subsequent handling), except in the case when, based on configuration in this AMF, the AMF is allowed to determine whether it can serve the UE (see(A) below for subsequent handling). The IP address or FQDN of the NSSF is locally configured in the AMF.

NOTE 2: The configuration in the AMF depends on operator's policy.
When the UE context in the AMF already includes an Allowed NSSAI for the corresponding Access Type, based on the configuration for this AMF, the AMF may be allowed to determine whether it can serve the UE (see(A) below for subsequent handling).
AMF or NSSF may have previously subscribed to slice load level and/or Observed Service Experience and/or Dispersion Analytics related network data analytics for a Network Slice from NWDAF, optionally for an Area of Interest composed of one or several TAIs. If AMF subscribes to analytics, AMF may determine that it cannot serve the UE based on received analytics (see(A) below). If AMF subscribes to notifications on changes on the Network Slice or Network Slice instance availability information from NSSF optionally indicating a list of supported TAIs, it may determine that it cannot serve the UE after the restriction notification is received (see(A) below). If AMF does not subscribe to notifications on changes on the availability information from NSSF, NSSF may take the analytics information into account when AMF queries NSSF (see (B) below).

NOTE 3: The configuration in the AMF depends on the operator's policy.

(A) Depending on fulfilling the configuration as described above, the AMF may be allowed to determine whether it can serve the UE, and the following is performed;
For the mobility from EPS to 5GS, the AMF first derives the serving PLMN value(s) of S-NSSAI(s) based on the HPLMN S-NSSAI(s) in the mapping of Requested NSSAI (in CM-IDLE state) or the HPLMN S-NSSAI(s) received from SMF+PGW-C(in CM-CONNECTED state). After that the AMF regards the derived value(s) as the Requested NSSAI.
For the inter PLMN within 5GC mobility, the new AMF derives the serving PLMN value(s) of S-NSSAI(s) based on the HPLMN S-NSSAI(s) in the mapping of Requested NSSAI. After that the AMF regards the derived value(s) as the Requested NSSAI.
AMF checks whether it can serve all the S-NSSAI(s) from the Requested NSSAI present in the Subscribed S-NSSAIs (potentially using configuration for mapping S-NSSAI values between HPLMN and Serving PLMN), or all the S-NSSAI(s) marked as default in the Subscribed S-NSSAIs in the case that no Requested NSSAI was provided or none of the S-NSSAIs in the Requested NSSAI are permitted, i.e. do not match any of the Subscribed S-NSSAIs or not available at the current UE's Tracking Area (see clause 5.15.3).
   If AMF has subscribed to slice load level and/or Observed Service Experience and/or Dispersion Analytics related network data analytics for a Network Slice from NWDAF, or if AMF had received a Network Slice restriction from NSSF that applies to the list of TAIs supported by the AMF, it may use that information to determine whether the AMF can serve the UE on the S-NSSAI(s) in the Requested NSSAI.
   If the AMF can serve the S-NSSAIs in the Requested NSSAI, the AMF remains the serving AMF for the UE. The Allowed NSSAI is then composed of the list of S-NSSAI(s) in the Requested NSSAI permitted based on the Subscribed S-NSSAIs and/or the list of S-NSSAI(s) for the Serving PLMN which are mapped to the HPLMN S-NSSAI(s) provided in the mapping of Requested NSSAI permitted based on the Subscribed S-NSSAIs, or, if neither Requested NSSAI nor the mapping of Requested NSSAI was provided or none of the S-NSSAIs in the Requested NSSAI are permitted, all the S-NSSAI(s) marked as default in the Subscribed S-NSSAIs and taking also into account the availability of the Network Slice instances as described in clause 5.15.8 that are able to serve the S-NSSAI(s) in the Allowed NSSAI in the current UE's Tracking Areas in addition to any Network Slice instance restriction for the S-NSSAI(s) in the Allowed NSSAI provided by the NSSF. If the AMF has received NSSRG Information for the Subscribed S-NSSAIs as part of the UE subscription information, it shall only include in the Allowed NSSAI S-NSSAIs that all share a common NSSRG (see clause 5.15.12). If at least one S-NSSAI in the Requested NSSAI is not available in the current UE's Tracking Area, then either the AMF may determine a Target NSSAI or step (B) is executed. The AMF also determines the mapping if the S-NSSAI(s) included in the Allowed NSSAI needs to be mapped to Subscribed S-NSSAI(s) values. If no Requested NSSAI is provided, or the mapping of the S-NSSAIs in Requested NSSAI to HPLMN S-NSSAIs is incorrect, or the Requested NSSAI includes an S-NSSAI that is not valid in the Serving PLMN, or the UE indicated that the Requested NSSAI is based on the Default Configured NSSAI, the AMF, based on the Subscribed S-NSSAI(s) and operator's configuration, may also determine the Configured NSSAI for the Serving PLMN and, if applicable, the associated mapping of the Configured NSSAI to HPLMN S-NSSAIs, so these can be configured in the UE. Then Step (C) is executed.
Else, the AMF queries the NSSF (see (B) below).

(B) When required as described above, the AMF needs to query the NSSF, and the following is performed;
The AMF queries the NSSF, with Requested NSSAI (excluding S-NSSAIs subject to NSSAA which are in “Pending” state and are not yet in the Allowed NSSAI, if any), Default Configured NSSAI Indication, mapping of Requested NSSAI to HPLMN S-NSSAIs, the Subscribed S-NSSAIs (with an indication if marked as default S-NSSAI), NSSRG Information (if provided by the UDM, see clause 5.15.12), any Allowed NSSAI it might have for the other Access Type (including its mapping to HPLMN S-NSSAIS), PLMN ID of the SUPI and UE's current Tracking Area.
Based on this information, local configuration, and other locally available information including RAN capabilities in the current Tracking Area for the UE or load level information for a Network Slice instance provided by the NWDAF, the NSSF does the following;
   It verifies which S-NSSAI(s) in the Requested NSSAI are permitted based on comparing the Subscribed S-NSSAIs with the S-NSSAIs in the mapping of Requested NSSAI to HPLMN S-NSSAIs. It considers the S-NSSAI(s) marked as default in the Subscribed S-NSSAIs in the case that no Requested NSSAI was provided or no S-NSSAI from the Requested NSSAI are permitted i.e. are not present in the Subscribed S-NSSAIs or not available e.g. at the current UE's Tracking Area. If NSSRG information is provided, the NSSF only selects S-NSSAIs that share a common NSSRG (see clause 5.15.12).
   If AMF has not subscribed to notifications on changes on the Network Slice or Network Slice instance availability information from NSSF and NSSF has subscribed to slice load level and/or Observed Service Experience and/or Dispersion Analytics related network data analytics for a Network Slice from NWDAF, NSSF may use the analytics information for the determination of the (Network Slice instance(s) and the) list of S-NSSAI(s) in the Allowed NSSAI(s) to serve the UE.
   It selects the Network Slice instance(s) to serve the UE. When multiple Network Slice instances in the UE's Tracking Area are able to serve a given S-NSSAI, based on operator's configuration, the NSSF may select one of them to serve the UE, or the NSSF may defer the selection of the Network Slice instance until a NF/service within the Network Slice instance needs to be selected.
   It determines the target AMF Set to be used to serve the UE, or, based on configuration, the list of candidate AMF(s), possibly after querying the NRF.

NOTE 4: If the target AMF(s) returned from the NSSF is the list of candidate AMF(s), the Registration Request message can only be redirected via the direct signalling between the initial AMF and the selected target AMF as described in clause 5.15.5.2.3. The NSSF does not provide the target AMF(s), when it provides a Target NSSAI in order to redirect or handover the UE to a cell of another TA as described in clause 5.3.4.3.3.
It determines the Allowed NSSAI(s) for the applicable Access Type, composed of the list of S-NSSAI(s) in the Requested NSSAI permitted based on the Subscribed S-NSSAIs and/or the list of S-NSSAI(s) for the Serving PLMN which are mapped to the HPLMN S-NSSAIs provided in the mapping of Requested NSSAI permitted based on the Subscribed S-NSSAIs, or, if neither Requested NSSAI nor the mapping of Requested NSSAI was provided or none of the S-NSSAIs in the Requested NSSAI are permitted, all the S-NSSAI(s) marked as default in the Subscribed S-NSSAIs, and taking also into account the availability of the Network Slice instances as described in clause 5.15.8 that are able to serve the S-NSSAI(s) in the Allowed NSSAI in the current UE's Tracking Areas. If NSSRG information applies, the NSSF only selects S-NSSAIs that share a common NSSRG (see clause 5.15.12).
   It also determines the mapping of each S-NSSAI of the Allowed NSSAI(s) to the Subscribed S-NSSAIs if necessary.
   Based on operator configuration, the NSSF may determine the NRF(s) to be used to select NFs/services within the selected Network Slice instance(s).
   Additional processing to determine the Allowed NSSAI(s) in roaming scenarios and the mapping to the Subscribed S-NSSAIs, as described in clause 5.15.6.
   If no Requested NSSAI is provided or the Requested NSSAI includes an S-NSSAI that is not valid in the Serving PLMN, or the mapping of the S-NSSAIs in Requested NSSAI to HPLMN S-NSSAIs is incorrect, or the Default Configured NSSAI Indication is received from AMF, the NSSF based on the Subscribed S-NSSAI(s) and operator configuration may also determine the Configured NSSAI for the Serving PLMN and, if applicable, the associated mapping of the Configured NSSAI to HPLMN S-NSSAIs, so these can be configured in the UE.
   If at least one S-NSSAI in the Requested NSSAI is not available in the current UE's Tracking Area, the NSSF may provide a Target NSSAI for the purpose of allowing the NG-RAN to redirect the UE to a cell of a TA in another frequency band supporting network slices not available in the current TA as described in clause 5.3.4.3.3.
The NSSF returns to the current AMF the Allowed NSSAI for the applicable Access Type, the mapping of each S-NSSAI of the Allowed NSSAI to the Subscribed S-NSSAIs if determined and the target AMF Set, or, based on configuration, the list of candidate AMF(s). The NSSF may return the NRF(s) to be used to select NFs/services within the selected Network Slice instance(s), and the NRF to be used to determine the list of candidate AMF(s) from the AMF Set. The NSSF may return NSI ID(s) to be associated to the Network Slice instance(s) corresponding to certain S-NSSAIs. NSSF may return the rejected S-NSSAI(s) as described in clause 5.15.4.1. The NSSF may return the Configured NSSAI for the Serving PLMN and the associated mapping of the Configured NSSAI to HPLMN S-NSSAIs. The NSSF may return Target NSSAI as described in clause 5.3.4.3.3.
Depending on the available information and based on configuration, the AMF may query the appropriate NRF (e.g. locally pre-configured or provided by the NSSF) with the target AMF Set. The NRF returns a list of candidate AMFs.
If AMF Re-allocation is necessary, the current AMF reroutes the Registration Request or forwards the UE context to a target serving AMF as described in clause 5.15.5.2.3.
Step (C) is executed.

(C) The serving AMF shall determine a Registration Area such that all S-NSSAIs of the Allowed NSSAI for this Registration Area are available in all Tracking Areas of the Registration Area (and also considering other aspects as described in clause 5.3.2.3) and then return to the UE this Allowed NSSAI and the mapping of the Allowed NSSAI to the Subscribed S-NSSAIs if provided. The AMF may return the rejected S-NSSAI(s) as described in clause 5.15.4.1.

NOTE 5: The S-NSSAIs in the Allowed NSSAI for Non-3GPP access are available homogeneously in the PLMN for the N3IWF case. For other types of Non 3GPP access the S-NSSAIs in the Allowed NSSAI for Non-3GPP access can be not available homogeneously all over the PLMN, for example different W-AGFs can support different TAIs that support different network slices.

When either no Requested NSSAI was included, or the mapping of the S-NSSAIs in Requested NSSAI to HPLMN S-NSSAIs is incorrect, or a Requested NSSAI is not considered valid in the PLMN and as such at least one S-NSSAI in the Requested NSSAI was rejected as not usable by the UE in the PLMN, or the UE indicated that the Requested NSSAI is based on the Default Configured NSSAI, the AMF may update the UE slice configuration information for the PLMN as described in clause 5.15.4.2.

If the Requested NSSAI does not include S-NSSAIs which map to S-NSSAIs of the HPLMN subject to Network Slice-Specific Authentication and Authorization and the AMF determines that no S-NSSAI can be provided in the Allowed NSSAI for the UE in the current UE's Tracking Area and if no default S-NSSAI(s) could be added as described in step(A), the AMF shall reject the UE Registration and shall include in the rejection message the list of Rejected S-NSSAIs, each of them with the appropriate rejection cause value.

If the Requested NSSAI includes S-NSSAIs which map to S-NSSAIs of the HPLMN subject to Network Slice-Specific Authentication and Authorization, the AMF shall include in the Registration Accept message an Allowed NSSAI containing only those S-NSSAIs that are not to be subject to Network Slice-Specific Authentication and Authorization and, based on the UE Context in AMF, those S-NSSAIs for which Network Slice-Specific Authentication and Authorization for at least one of the corresponding HPLMN S-NSSAIs succeeded previously regardless the Access Type, if any.

The AMF shall also provide the list of Rejected S-NSSAIs, each of them with the appropriate rejection cause value.

If the AMF determined the Target NSSAI or received a Target NSSAI from the NSSF, the AMF should provide the Target NSSAI to the PCF for retrieving a corresponding RFSP as described in clause 5.3.4.3.1 or, if the PCF is not deployed, the AMF should determine a corresponding RFSP based on local configuration. Then the AMF provides the Target NSSAI and the corresponding RFSP to the NG-RAN as described in clause 5.3.4.3.3. The S-NSSAIs which map to S-NSSAIs of the HPLMN subject to Network Slice-Specific Authentication and Authorization is ongoing are in “pending” state in the AMF and shall be included in the Pending NSSAI. The Pending NSSAI may contain a mapping of the S-NSSAI(s) for the Serving PLMN to the HPLMN S-NSSAIs, if applicable. The UE shall not include in the Requested NSSAI any of the S-NSSAIs from the Pending NSSAI the UE stores, regardless of the Access Type.

If:
all the S-NSSAI(s) in the Requested NSSAI are still to be subject to Network

Slice-Specific Authentication and Authorization: or
no Requested NSSAI was provided or none of the S-NSSAIs in the Requested NSSAI matches any of the Subscribed S-NSSAIs, and all the S-NSSAI(s) marked as default in the Subscribed S-NSSAIs are to be subject to Network Slice-Specific Authentication and Authorization:
the AMF shall provide a “NSSAA to be performed” indicator and no Allowed NSSAI to the UE in the Registration Accept message. Upon receiving the Registration Accept message, the UE is registered in the PLMN but shall wait for the completion of the Network Slice-Specific Authentication and Authorization without attempting to use any service provided by the PLMN on any access, except e.g. emergency services (see TS 24.501[47]), until the UE receives an allowed NSSAI.

Then, the AMF shall initiate the Network Slice-Specific Authentication and Authorization procedure as described in clause 5.15.10 for each S-NSSAI that requires it, except, based on Network policies, for those S-NSSAIs for which Network Slice-Specific Authentication and Authorization have been already initiated on another Access Type for the same S-NSSAI(s). At the end of the Network Slice-Specific Authentication and Authorization steps, the AMF by means of the UE Configuration Update procedure shall provide a new Allowed NSSAI to the UE which also contains the S-NSSAIs subject to Network Slice-Specific Authentication and Authorization for which the authentication and authorization is successful. The AMF may perform AMF selection when NSSAA completes for the S-NSSAIs subject to S-NSSAI in “pending” status. If an AMF change is required, this shall be triggered by the AMF using the UE Configuration Update procedure indicating a UE re-registration is required. The S-NSSAIs which were not successfully authenticated and authorized are not included in the Allowed NSSAI and are included in the list of Rejected S-NSSAIs with a rejection cause value indicating Network Slice-Specific Authentication and Authorization failure.

Once completed the Network Slice-Specific (re-) Authentication and (re-) Authorization procedure, if the AMF determines that no S-NSSAI can be provided in the Allowed NSSAI for the UE, which is already authenticated and authorized successfully by a PLMN, and if no default S-NSSAI(s) could be added as described in step(A), the AMF shall execute the Network-initiated Deregistration procedure described in clause 4.2.2.3.3 of TS 23.502[3] and shall include in the explicit De-Registration Request message the list of Rejected S-NSSAIs, each of them with the appropriate rejection cause value.

If an S-NSSAI is rejected with a rejection cause value indicating Network Slice-Specific Authentication and Authorization failure or revocation, the UE can re-attempt to request the S-NSSAI based on policy, local in the UE.

### 5.15.5.2.2 Modification of the Set of Network Slice(s) for a UE

The set of Network Slices for a UE can be changed at any time while the UE is registered with a network, and may be initiated by the network, or by the UE, under certain conditions as described below.

The network, based on local policies, subscription changes and/or UE mobility and/or UE Dispersion data classification, operational reasons (e.g. a Network Slice instance is no longer available or load level information or service experience for a Network Slice or network slice instance provided by the NWDAF), may change the set of Network Slice(s) to which the UE is registered and provide the UE with a new Registration Area and/or Allowed NSSAI and the mapping of this Allowed NSSAI to HPLMN S-NSSAIs, for each Access Type over which the UE is registered. In addition, the network may provide the Configured NSSAI for the Serving PLMN, the associated mapping information, and the rejected S-NSSAIs. Based on the local configurations or change in subscription from the UDM for the UE, the network may change the mapping of a S-NSSAI in allowed NSSAI and a mapped HPLMN S-NSSAI. In case the mapped HPLMN S-NSSAI is subject to NSSAA and the serving AMF doesn't have NSSAA status stored for the HPLMN S-NSSAI i.e. the NSSAA procedure has not been executed for the HPLMN S-NSSAI before, then the AMF removes the S-NSSAI from the allowed NSSAI and stores the S-NSSAI in the pending NSSAI list and sends new allowed NSSAI and the pending NSSAI to the UE and starts the NSSAA procedure for the HPLMN S-NSSAI. The network may perform such a change over each Access Type during a Registration procedure or trigger a notification towards the UE of the change of the Network Slices using a UE Configuration Update procedure as specified in clause 4.2.4 of TS 23.502[3]. The new Allowed NSSAI(s) and the mapping to HPLMN S-NSSAIs are determined as described in clause 5.15.5.2.1 (an AMF Re-allocation may be needed). The AMF provides the UE with;
an indication that the acknowledgement from UE is required;
Configured NSSAI for the Serving PLMN (if required), rejected S-NSSAI(s) (if required) and TAI list, and
the new Allowed NSSAI with the associated mapping of Allowed NSSAI for each Access Type (as applicable) unless the AMF cannot determine the new Allowed NSSAI (e.g. all S-NSSAIs in the old Allowed NSSAI have been removed from the Subscribed S-NSSAIs).

### Furthermore;

If the changes to the Allowed NSSAI require the UE to perform immediately a Registration procedure because they affect the existing connectivity to Network Slices (e.g. the new S-NSSAIs require a separate AMF that cannot be determined by the current serving AMF, or the AMF cannot determine the Allowed NSSAI) or due to AMF local policies also when the changes does not affect the existing connectivity to Network Slices;
   The serving AMF indicates to the UE the need for the UE to perform a Registration procedure without including the GUAMI or 5G-S-TMSI in the access stratum signalling after entering CM-IDLE state. The AMF shall release the NAS signalling connection to the UE to allow to enter CM-IDLE after receiving the acknowledgement from UE.
   When the UE receives indications to perform a Registration procedure without including the GUAMI or 5G-S-TMSI in the access stratum signalling after entering CM-IDLE state, then:
      The UE deletes any stored (old) Allowed NSSAI and associated mapping as well as any (old) rejected S-NSSAI.
      The UE shall initiate a Registration procedure with the registration type Mobility Registration Update after the UE enters CM-IDLE state as specified in as described in step 4 of clause 4.2.4.2 of TS 23.502[3]. The UE shall include a Requested NSSAI (as described in clause 5.15.5.2.1) with the associated mapping of Requested NSSAI in the Registration Request message. Also, the UE shall include, subject to the conditions set out in clause 5.15.9, a Requested NSSAI in access stratum signalling but no GUAMI.

If there are established PDU Session(s) associated with emergency services, then the serving AMF indicates to the UE the need for the UE to perform a Registration procedure but does not release the NAS signalling connection to the UE. The UE performs the Registration procedure only after the release of the PDU Session(s) used for the emergency services.

In addition to sending the new Allowed NSSAI to the UE, when a Network Slice used for a one or multiple PDU Sessions is no longer available for a UE, the following applies:
If the Network Slice becomes no longer available under the same AMF (e.g. due to UE subscription change), the AMF indicates to the SMF(s) which PDU Session ID(s) corresponding to the relevant S-NSSAI shall be released. SMF releases the PDU Session according to clause 4.3.4.2 of TS 23.502[3].
If the Network Slice becomes no longer available upon a change of AMF (e.g. due to Registration Area change), the new AMF indicates to the old AMF that the PDU Session(s) corresponding to the relevant S-NSSAI shall be released. The old AMF informs the corresponding SMF(s) to release the indicated PDU Session(s). The SMF(s) release the PDU Session(s) as described in clause 4.3.4 of TS 23.502 [3]. Then the new AMF modifies the PDU Session Status correspondingly. The PDU Session(s) context is locally released in the UE after receiving the PDU Session Status in the Registration Accept message.

The UE uses either the URSP rules (which includes the NSSP) or the UE Local Configuration as defined in clause 6.1.2.2.1 of TS 23.503 to determine whether ongoing traffic can be routed over existing PDU Sessions belonging to other Network Slices or establish new PDU Session(s) associated with same/other Network Slice.

In order to change the set of S-NSSAIs the UE is registered to over an Access Type, the UE shall initiate a Registration procedure over this Access Type as specified in clause 5.15.5.2.1.

If, for an established PDU Session;
none of the values of the S-NSSAIs of the HPLMN in the mapping of the Requested NSSAI to S-NSSAIs of the HPLMN included in the Registration Request matches the S-NSSAI of the HPLMN associated with the PDU Session: or
none of the values of the S-NSSAIs in the Requested NSSAI matches the value of the S-NSSAI of HPLMN associated with the PDU Session and the mapping of the Requested NSSAI to S-NSSAIs of the HPLMN is not included in the Registration Request,
the network shall release this PDU Session as follows;
the AMF informs the corresponding SMF(s) to release the indicated PDU Session(s). The SMF(s) release the PDU Session(s) as described in clause 4.3.4 of TS 23.502[3]. Then the AMF modifies the PDU Session Status correspondingly. The PDU Session(s) context is locally released in the UE after receiving the PDU Session Status from the AMF.

A change of the set of S-NSSAIs (whether UE or Network initiated) to which the UE is registered may, subject to operator policy, lead to AMF change, as described in clause 5.15.5.2.1.

### 5.15.5.2.3 AMF Re-Allocation Due to Network Slice(s) Support

During a Registration procedure in a PLMN, if the network decides that the UE should be served by a different AMF based on Network Slice(s) aspects, then the AMF that first received the Registration Request shall redirect the Registration request to target AMF via the 5G-AN or via direct signalling between the initial AMF and the target AMF. If the target AMF(s) are returned from the NSSF and identified by a list of candidate AMF(s), the redirection message shall only be sent via the direct signalling between the initial AMF and the target AMF. If the redirection message is sent by the AMF via the 5G-AN, the message shall include information for selection of a new AMF to serve the UE.

When during a Registration procedure the UE requests a new S-NSSAI which is not supported in the UE's current Tracking Area, the serving AMF itself or by interacting with the NSSF as described in clause 5.15.5.2.1 may determine a Target NSSAI. The AMF provides the Target NSSAI to the NG-RAN and the NG-RAN may apply redirection or handover of the UE to a cell in another TA supporting the Target NSSAI as described in clause 5.3.4.3.3.

During a EPS to 5GS handover using N26 interface procedure, if the network decides that the UE should be served by a different AMF based on Network Slice(s) aspects, then the AMF, which received the Forward Relocation Request from MME, shall forward the UE context to target AMF via direct signalling between the initial AMF and the target AMF as described in clause 4.11.1.2.2 of TS 23.502[3].

For a UE that is already registered, the system shall support a redirection initiated by the network of a UE from its serving AMF to a target AMF due to Network Slice(s) considerations (e.g. the operator has changed the mapping between the Network Slice instances and their respective serving AMF(s)). Operator policy determines whether redirection between AMFs is allowed.

4.2.2.2.3 Registration with AMF Re-Allocation

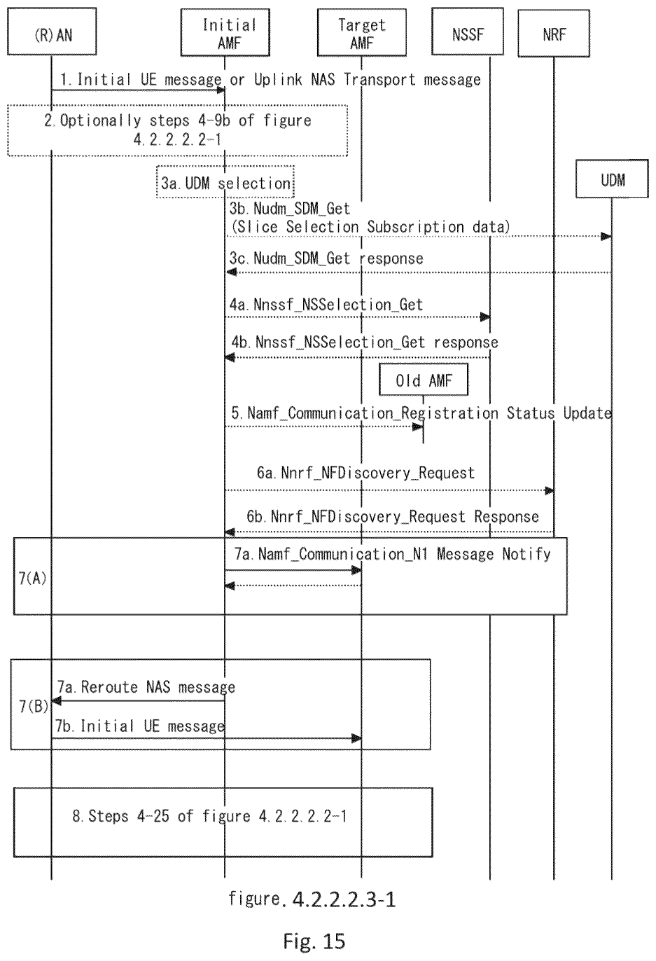

When an AMF receives a Registration request, the AMF may need to reroute the Registration request to another AMF, e.g. when the initial AMF is not the appropriate AMF to serve the UE. The Registration with AMF re-allocation procedure, described in FIG. 15 (FIG. 4.2.2.2.3-1), is used to reroute the NAS message of the UE to the target AMF during a Registration procedure.

The initial AMF and the target AMF register their capability at the NRF.
1. If the UE is in CM-IDLE State, steps 1 and 2 of FIG. 4.2.2.2.2-1 have occurred, and the (R)AN sends the Registration request message within an Initial UE message to the initial AMF. If the UE is in CM-CONNECTED state and triggers registration procedure, the NG-RAN sends Registration request message in the Uplink NAS Transport message to the serving AMF which is initial AMF. The AMF may skip step 2-3.
2. If the AMF needs the SUPI and/or UE's subscription information to decide whether to reroute the Registration Request or if the Registration Request was not sent integrity protected or integrity protection is indicated as failed, then AMF performs steps 4 to 9a or to 9b of FIG. 4.2.2.2.2-1.
3a. [Conditional] If the initial AMF needs UE's subscription information to decide whether to reroute the Registration Request and UE's slice selection subscription information was not provided by old AMF, the AMF selects a UDM as described in clause 6.3.8 of TS 23.501[2].
3b. Initial AMF to UDM: Nudm_SDM_Get (SUPI, Slice Selection Subscription data).

The initial AMF request UE's Slice Selection Subscription data from UDM by invoking the Nudm_SDM_Get (see clause 5.2.3.3.1) service operation. UDM may get this information from UDR by Nudr_DM_Query (SUPI, Slice Selection Subscription data).

For a Disaster Roaming Registration, the AMF may provide the indication of Disaster Roaming service to the UDM.
3c. UDM to initial AMF: Response to Nudm_SDM_Get. The AMF gets the Slice Selection Subscription data including Subscribed S-NSSAIs.

UDM responds with slice selection subscription data to initial AMF.

For a Disaster Roaming Registration, the UDM responds with the slice selection subscription data for a Disaster Roaming service to initial AMF based on the local policy and/or the local configuration as specified in clause 5.40.4 of TS 23.501[2].

4a. [Conditional] Initial AMF to NSSF: Nnssf_NSSelection_Get (Requested NSSAI, [Mapping Of Requested NSSAI], Subscribed S-NSSAI(s) with the default S-NSSAI indication, [NSSRG Information], TAI, Allowed NSSAI for the other access type (if any), [Mapping of Allowed NSSAI], PLMN ID of the SUPI).

If there is a need for slice selection, (see clause 5.15.5.2.1 of TS 23.501[2]), e.g. the initial AMF cannot serve all the S-NSSAI(s) from the Requested NSSAI permitted by the subscription information, the initial AMF invokes the Nnssf_NSSelection_Get service operation from the NSSF by including Requested NSSAI, optionally Mapping Of Requested NSSAI, Subscribed S-NSSAIs with the default S-NSSAI indication, [NSSRG Information], Allowed NSSAI for the other access type (if any), Mapping of Allowed NSSAI, PLMN ID of the SUPI and the TAI of the UE.

The AMF includes, if available, the NSSRG Information for the S-NSSAIs of the HPLMN, defined in clause 5.15.12 of TS 23.501[2], including information whether the UE has indicated support of the subscription-based restrictions to simultaneous registration of network slices, and whether the UDM has indicated to provide all subscribed S-NSSAIs for non-supporting UEs.
4b. [Conditional] NSSF to Initial AMF: Response to Nnssf_NSSelection_Get (AMF Set or list of AMF addresses, Allowed NSSAI for the first access type, [Mapping Of Allowed NSSAI], [Allowed NSSAI for the second access type], [Mapping of Allowed NSSAI], [NSI ID(s)], [NRF(s)], [List of rejected (S-NSSAI(s), cause value(s))], [Configured NSSAI for the Serving PLMN], [Mapping Of Configured NSSAI]).

The NSSF performs the steps specified in point (B) in clause 5.15.5.2.1 of TS 23.501[2]. The NSSF returns to initial AMF the Allowed NSSAI for the first access type, optionally the Mapping Of Allowed NSSAI, the Allowed NSSAI for the second access type (if any), optionally the Mapping of Allowed NSSAI and the target AMF Set or, based on configuration, the list of candidate AMF(s). The NSSF may return NSI ID(s) associated to the Network Slice instance(s) corresponding to certain S-NSSAI(s). The NSSF may return the NRF(s) to be used to select NFs/services within the selected Network Slice instance(s). It may return also information regarding rejection causes for S-NSSAI(s) not included in the Allowed NSSAI. The NSSF may return Configured NSSAI for the Serving PLMN, and possibly the associated mapping of the Configured NSSAI. If the NSSRG information was included in the request, the NSSF provides the Configured NSSAI as described in clause 5.15.12 of TS 23.501[2].

NOTE 1: The NRF(s) returned by the NSSF, if any, belong to any level of NRF (see clause 6.2.6 of TS 23.501[2]) according to the deployment decision of the operator.
5. [Conditional] Initial AMF to old AMF: Namf_Communication_RegistrationStatus Update (failure cause).

If the UE was in CM-IDLE and another AMF is selected, the initial AMF sends a reject indication to the old AMF telling that the UE Registration procedure did not fully complete at the initial AMF. The old AMF continues as if the Namf_Communication_UEContextTransfer had never been received.
6a. [Conditional] Initial AMF to NRF: Nnrf_NFDiscovery_Request (NF type, AMF Set).

If the initial AMF does not locally store the target AMF address, and if the initial AMF intends to use direct reroute to target AMF or the reroute via (NG-R) AN message needs to include AMF address, then the initial AMF invokes the Nnrf_NFDiscovery_Request service operation from the NRF to find a proper target AMF which has required NF capabilities to serve the UE. The NF type is set to AMF. The AMF Set is included in the Nnrf_NFDiscovery_Request.
6b. [Conditional] NRF to AMF: Response to Nnrf_NFDiscovery_Request (list of (AMF pointer, AMF address, plus additional selection rules and NF capabilities)).

The NRF replies with the list of potential target AMF(s). The NRF may also provide the details of the services offered by the candidate AMF(s) along with the notification end-point for each type of notification service that the selected AMF had registered with the NRF, if available. As an alternative, it provides a list of potential target AMFs and their capabilities, and optionally, additional selection rules. Based on the information about registered NFs and required capabilities, a target AMF is selected by the initial AMF.

If the security association has been established between the UE and initial AMF, to avoid a registration failure, the initial AMF shall forward the NAS message to the target AMF by executing step 7(A).

NOTE 2: The security context in the initial AMF is not transferred to the target AMF if initial AMF forward the NAS message to the target AMF via (R)AN. In this case the UE rejects the NAS message sent from target AMF as the security context in the UE and target AMF are not synchronized.

NOTE 3: Network slice isolation cannot be completely maintained in case the AMF reallocation is executed by step 7(A).

If the initial AMF is not part of the target AMF Set, and is not able to get a list of candidate AMF(s) by querying the NRF with the target AMF Set (e.g. the NRF locally pre-configured on AMF does not provide the requested information, the query to the appropriate NRF provided by the NSSF is not successful, or the initial AMF has knowledge that the initial AMF is not authorized as serving AMF etc.) then the initial AMF shall forward the NAS message to the target AMF via (R)AN executing step 7(B) unless the security association has been established between the UE and initial AMF: the Allowed NSSAI and the AMF Set are included to enable the (R)AN to select the target AMF as described in clause 6.3.5 of TS 23.501[2].
7 (A). If the initial AMF, based on local policy and subscription information, decides to forward the NAS message to the target AMF directly, the initial AMF invokes the Namf_Communication_NIMessageNotify to the target AMF, carrying the rerouted NAS message. The Namf_Communication_NIMessageNotify service operation includes AN access information (e.g. the information enabling (R)AN to identify the N2 terminating point, CAG Identifier(s) of the CAG cell) and the complete Registration Request message in clear text as specified in TS 33.501 [15], and the UE's SUPI and MM Context if available. If the initial AMF has obtained the information from the NSSF as described at step 4b, that information except the AMF Set or list of AMF addresses is included. The target AMF then updates the (R)AN with a new updated N2 termination point for the UE in the first message from target AMF to RAN in step 8.
7(B). [Conditional] if the UE was in CM-IDLE, if the initial AMF, based on local policy and subscription information, decides to forward the NAS message to the target AMF via (R)AN unless the target AMF(s) are returned from the NSSF and identified by a list of candidate AMF(s), the initial AMF sends a NGAP Reroute NAS Request message to the (R)AN (step 7a). The NGAP Reroute Request NAS message includes the information about the target AMF, and the complete Registration Request message. If the initial AMF has obtained the information as described at step 4b, that information is included. The (R)AN sends the Initial UE message to the target AMF (step 7b) indicating reroute due to slicing including the information from step 4b that the NSSF provided.

Editor's note: It is FFS whether for a UE in CM-CONNECTED mode step 7(B) can also apply.
8. After receiving the Registration Request message transmitted at step 7(A) a or step 7(B) b, the target AMF continues with the Registration procedure from step 4 until 22 of FIG. 4.2.2.2.2-1 (with the target AMF corresponding to the new AMF), which includes the UE context retrieved from old AMF. If the 5G security context is received from the initial AMF, the target AMF continue using that one instead of the 5G security context the target AMF may have retrieved from the old AMF. If the initial AMF decides to forward the NAS message to the target AMF (step 7(A), the first message from the target AMF to (R)AN (either Initial Context Setup Request, or Downlink NAS Transport) contain the AMF name of the initial AMF and target AMF UE NGAP ID.

### Modifications and Alternatives

Detailed aspects have been described above. As those skilled in the art will appreciate, a number of modifications and alternatives can be made to the above aspects whilst still benefiting from the disclosures embodied therein. By way of illustration only a number of these alternatives and modifications will now be described.

In the above description, the UE 3 and the network apparatus are described for ease of understanding as having a number of discrete modules (such as the communication control modules). Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities. These modules may also be implemented in software, hardware, firmware or a mix of these.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like.

In the above aspects, a number of software modules were described. As those skilled in the art will appreciate, the software modules may be provided in compiled or un-compiled form and may be supplied to the UE 3 and the network apparatus as a signal over a computer network, or on a recording medium. Further, the functionality performed by part or all of this software may be performed using one or more dedicated hardware circuits. However, the use of software modules is preferred as it facilitates the updating of the UE 3 and the network apparatus in order to update their functionalities.

In the above aspects, a 3GPP radio communications (radio access) technology is used. However, any other radio communications technology (e.g. WLAN, Wi-Fi, WiMAX, Bluetooth, etc.) and other fix line communications technology (e.g. BBF Access, Cable Access, optical access, etc.) may also be used in accordance with the above aspects.

Items of user equipment might include, for example, communication devices such as mobile telephones, smartphones, user equipment, personal digital assistants, laptop/tablet computers, web browsers, e-book readers and/or the like. Such mobile (or even generally stationary) devices are typically operated by a user, although it is also possible to connect so-called ‘Internet of Things’ (IoT) devices and similar machine-type communication (MTC) devices to the network. For simplicity, the present application refers to mobile devices (or UEs) in the description but it will be appreciated that the technology described can be implemented on any communication devices (mobile and/or generally stationary) that can connect to a communications network for sending/receiving data, regardless of whether such communication devices are controlled by human input or software instructions stored in memory.

Various other modifications will be apparent to those skilled in the art and will not be described in further detail here.

As will be appreciated by one of skill in the art, the present disclosure may be embodied as a method, and system. Accordingly, the present disclosure may take the form of an entirely hardware embodiment, a software embodiment or an embodiment combining software and hardware aspects.

It will be understood that each block of the block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. A general-purpose processor may be a microprocessor, but in the alternative, the processor may be any conventional processor, controller, microcontroller, or state machine. A processor may also be implemented as a combination of computing devices, e.g., a plurality of microprocessors, one or more microprocessors, or any other such configuration.

The methods or algorithms described in connection with the examples disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor. The processor and the storage medium may reside in an ASIC.

The previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

While the disclosure has been particularly shown and described with reference to exemplary Aspects thereof, the disclosure is not limited to these Aspects. It will be understood by those of ordinary skill in the art that various changes in form and details may be made therein without departing from the spirit and scope of the present disclosure as defined by this document. For example, the Aspects above are not limited to 5GS, and the Aspects are also applicable to communication system other than 5GS (e.g., 6G system, 5G beyond system).

### Supplementary Notes

The whole or part of the example Aspects disclosed above can be described as, but not limited to, the following supplementary notes.

### (Supplementary Note 1)

A method of a communication apparatus, the method comprising:
changing status of Single Network Slice Selection Assistance Information (S-NSSAI) included in Allowed Network Slice Selection Assistance Information (NSSAI); and
sending Pending NSSAI including the S-NSSAI in a case of changing the status.

### (Supplementary Note 2)

The method according to supplementary note 1,
wherein the status indicates whether the S-NSSAI is subject to Network Slice-Specific Authentication and Authorization (NSSAA) procedure,
wherein the changing the status includes changing from the S-NSSAI which is not subject to the NSSAA procedure to the S-NSSAI which is subject to the NSSAA procedure, and
wherein the sending the Pending NSSAI includes sending the Pending NSSAI in a case of changing from the S-NSSAI which is not subject to the NSSAA procedure to the S-NSSAI which is subject to the NSSAA procedure.

### (Supplementary Note 3)

The method according to supplementary note 2, further comprising: performing the NSSAA procedure for the S-NSSAI.

### (Supplementary Note 4)

The method according to any one of supplementary notes 1 to 3, further comprising:
receiving information indicating that the status is changed; and
changing the status based on the information.

### (Supplementary Note 5)

The method according to any one of supplementary notes 1 to 4, further comprising:
performing procedure for releasing a Protocol Data Unit (PDU) session related to the S-NSSAI in a case where the PDU session is established.

### (Supplementary Note 6)

The method according to any one of supplementary notes 1 to 5,
wherein the sending the Pending NSSAI includes sending the Pending NSSAI using at least one of 3GPP access and Non-3GPP access.

### (Supplementary Note 7)

The method according to any one of supplementary notes 1 to 6,
wherein the communication apparatus is an Access and Mobility Management Function (AMF) apparatus.

### (Supplementary Note 8)

A method of a communication apparatus, the method comprising:
receiving Allowed Network Slice Selection Assistance Information (NSSAI) including Single Network Slice Selection Assistance Information (S-NSSAI);
receiving Pending NSSAI including the S-NSSAI in a case where status of the S-NSSAI is changed; and
updating the Allowed NSSAI and the Pending NSSAI.

### (Supplementary Note 9)

The method according to supplementary note 8,
wherein the status indicates whether the S-NSSAI is subject to Network Slice-Specific Authentication and Authorization (NSSAA) procedure.

### (Supplementary Note 10)

The method according to supplementary note 8 or 9, further comprising:
performing procedure for releasing a Protocol Data Unit (PDU) session related to the S-NSSAI in a case of receiving the Pending NSSAI.

### (Supplementary Note 11)

The method according to any one of supplementary notes 8 to 10,
wherein the updating the Allowed NSSAI and the Pending NSSAI includes removing the S-NSSAI from the Allowed NSSAI and storing the S-NSSAI in the Pending NSSAI.

### (Supplementary Note 12)

The method according to any one of supplementary notes 8 to 11,
wherein the communication apparatus is a User Equipment.

### (Supplementary Note 13)

A method of a communication apparatus, the method comprising:
changing status of Single Network Slice Selection Assistance Information (S-NSSAI) included in Allowed Network Slice Selection Assistance Information (NSSAI);
performing Network Slice-Specific Authentication and Authorization (NSSAA) procedure for the S-NSSAI in a case of changing the status;
receiving a message related to the S-NSSAI; and
sending a cause value,
wherein the cause value indicates that the S-NSSAI is in Pending NSSAI.

### (Supplementary Note 14)

The method according to supplementary note 13,
wherein the status indicates whether the S-NSSAI is subject to the NSSAA procedure,
wherein the changing the status includes changing from the S-NSSAI which is not subject to the NSSAA procedure to the S-NSSAI which is subject to the NSSAA procedure, and
wherein the performing the NSSAA procedure includes performing the NSSAA procedure in a case of changing from the S-NSSAI which is not subject to the NSSAA procedure to the S-NSSAI which is subject to the NSSAA procedure.

### (Supplementary Note 15)

The method according to supplementary note 13 or 14, further comprising:
receiving information indicating that the status is changed; and
determining that the status is changed based on the information.

### (Supplementary Note 16)

The method according to any one of supplementary notes 13 to 15, further comprising:
performing procedure for releasing a Protocol Data Unit (PDU) session related to the S-NSSAI in a case where the PDU session is established.

### (Supplementary Note 17)

The method according to any one of supplementary notes 13 to 16, further comprising:
storing the S-NSSAI in the Allowed NSSAI after performing the NSSAA procedure for the S-NSSAI.

### (Supplementary Note 18)

The method according to any one of supplementary notes 13 to 17, further comprising:
sending the Allowed NSSAI in a case where the NSSAA procedure completes successfully.

### (Supplementary Note 19)

The method according to any one of supplementary notes 13 to 18, further comprising:
sending Rejected NSSAI including the S-NSSAI in a case where the NSSAA procedure fails; and
storing the Rejected NSSAI.

### (Supplementary Note 20)

The method according to any one of supplementary notes 13 to 19,
wherein the communication apparatus is an Access and Mobility Management Function (AMF) apparatus.

### (Supplementary Note 21)

A method of a communication apparatus, the method comprising:
receiving Allowed Network Slice Selection Assistance Information (NSSAI) including Single Network Slice Selection Assistance Information (S-NSSAI);
sending a message including the S-NSSAI;
receiving a cause value,
wherein the cause value indicates that status indicating that the S-NSSAI is not subject to Network Slice-Specific Authentication and Authorization (NSSAA) procedure is changed to status indicating that the S-NSSAI is subject to the NSSAA procedure; and
suspending a process related to the S-NSSAI.

### (Supplementary Note 22)

The method according to supplementary note 21, further comprising:
updating the Allowed NSSAI in a case where the NSSAA procedure for the S-NSSAI is ongoing.

### (Supplementary Note 23)

The method according to supplementary note 22,
wherein the updating the Allowed NSSAI includes removing the S-NSSAI from the Allowed NSSAI and storing the S-NSSAI in Pending NSSAI.

### (Supplementary Note 24)

The method according to supplementary note 21, further comprising:
determining whether the S-NSSAI has been authenticated and authorized successfully in a case where the NSSAA procedure for the S-NSSAI is ongoing;
keeping the S-NSSAI in the Allowed NSSAI in a case of determining that the S-NSSAI has been authenticated and authorized successfully; and
removing the S-NSSAI from the Allowed NSSAI and storing the S-NSSAI in Pending NSSAI in a case of determining that the S-NSSAI has not been authenticated and authorized successfully.

### (Supplementary Note 25)

The method according to supplementary note 21, further comprising:
determining whether the NSSAA procedure for the S-NSSAI is for first time in a case where the NSSAA procedure for the S-NSSAI is ongoing;
keeping the S-NSSAI in the Allowed NSSAI in a case of determining that the NSSAA procedure for the S-NSSAI is for first time; and
removing the S-NSSAI from the Allowed NSSAI and storing the S-NSSAI in Pending NSSAI in a case of determining that the NSSAA procedure for the S-NSSAI is not for first time.

### (Supplementary Note 26)

The method according to any one of supplementary notes 21 to 25, further comprising:
performing procedure for releasing a Protocol Data Unit (PDU) session related to the S-NSSAI in a case where the NSSAA procedure for the S-NSSAI is ongoing.

### (Supplementary Note 27)

The method according to any one of supplementary notes 21 to 26, further comprising:
suspending process related to the S-NSSAI in a case where the NSSAA procedure for the S-NSSAI is ongoing.

### (Supplementary Note 28)

The method according to any one of supplementary notes 21 to 27, further comprising:
receiving the Allowed NSSAI in a case where the NSSAA procedure completes successfully.

### (Supplementary Note 29)

The method according to any one of supplementary notes 21 to 28, further comprising:
receiving Rejected NSSAI in a case where the NSSAA procedure fails; and
storing the Rejected NSSAI.

### (Supplementary Note 30)

The method according to any one of supplementary notes 21 to 29,
wherein the communication apparatus is a User Equipment.

### (Supplementary Note 31)

A communication apparatus comprising:
means for changing status of Single Network Slice Selection Assistance Information (S-NSSAI) included in Allowed Network Slice Selection Assistance Information (NSSAI); and
means for sending Pending NSSAI including the S-NSSAI in a case of changing the status.

### (Supplementary Note 32)

The communication apparatus according to supplementary note 31, further comprising:
wherein the status indicates whether the S-NSSAI is subject to Network Slice-Specific Authentication and Authorization (NSSAA) procedure,
means for changing from the S-NSSAI which is not subject to the NSSAA procedure to the S-NSSAI which is subject to the NSSAA procedure; and
means for sending the Pending NSSAI in a case of changing from the S-NSSAI which is not subject to the NSSAA procedure to the S-NSSAI which is subject to the NSSAA procedure.

### (Supplementary Note 33)

The communication apparatus according to supplementary note 32, further comprising:
means for performing the NSSAA procedure for the S-NSSAI.

### (Supplementary Note 34)

The communication apparatus according to any one of supplementary notes 31 to 33, further comprising:
means for receiving information indicating that the status is changed; and
means for changing the status based on the information.

### (Supplementary Note 35)

The communication apparatus according to any one of supplementary notes 31 to 34, further comprising:
means for performing procedure for releasing a Protocol Data Unit (PDU) session related to the S-NSSAI in a case where the PDU session is established.

### (Supplementary Note 36)

The communication apparatus according to any one of supplementary notes 31 to 35, further comprising:
means for sending the Pending NSSAI using at least one of 3GPP access and Non-3GPP access.

### (Supplementary Note 37)

The communication apparatus according to any one of supplementary notes 31 to 36,
wherein the communication apparatus is an Access and Mobility Management Function (AMF) apparatus.

### (Supplementary Note 38)

A communication apparatus comprising:
means for receiving Allowed Network Slice Selection Assistance Information (NSSAI) including Single Network Slice Selection Assistance Information (S-NSSAI);
means for receiving Pending NSSAI including the S-NSSAI in a case where status of the S-NSSAI is changed; and
means for updating the Allowed NSSAI and the Pending NSSAI.

### (Supplementary Note 39)

The communication apparatus according to supplementary note 38,
wherein the status indicates whether the S-NSSAI is subject to Network Slice-Specific Authentication and Authorization (NSSAA) procedure.

### (Supplementary Note 40)

The communication apparatus according to supplementary note 38 or 39, further comprising:
means for performing procedure for releasing a Protocol Data Unit (PDU) session related to the S-NSSAI in a case of receiving the Pending NSSAI.

### (Supplementary Note 41)

The communication apparatus according to any one of supplementary notes 38 to 40, further comprising:
means for removing the S-NSSAI from the Allowed NSSAI; and
means for storing the S-NSSAI in the Pending NSSAI.

### (Supplementary Note 42)

The communication apparatus according to any one of supplementary notes 38 to 41,
wherein the communication apparatus is a User Equipment.

### (Supplementary Note 43)

A communication apparatus comprising:
means for changing status of Single Network Slice Selection Assistance Information (S-NSSAI) included in Allowed Network Slice Selection Assistance Information (NSSAI);
means for performing Network Slice-Specific Authentication and Authorization (NSSAA) procedure for the S-NSSAI in a case of changing the status;
means for receiving a message related to the S-NSSAI; and
means for sending a cause value,
wherein the cause value indicates that the S-NSSAI is in Pending NSSAI.

### (Supplementary Note 44)

The communication apparatus according to supplementary note 43, further comprising:
wherein the status indicates whether the S-NSSAI is subject to the NSSAA procedure,
means for changing from the S-NSSAI which is not subject to the NSSAA procedure to the S-NSSAI which is subject to the NSSAA procedure; and
means for performing the NSSAA procedure in a case of changing from the S-NSSAI which is not subject to the NSSAA procedure to the S-NSSAI which is subject to the NSSAA procedure.

### (Supplementary Note 45)

The communication apparatus according to supplementary note 43 or 44, further comprising:
means for receiving information indicating that the status is changed; and
means for determining that the status is changed based on the information.

### (Supplementary Note 46)

The communication apparatus according to any one of supplementary notes 43 to 45, further comprising:
means for performing procedure for releasing a Protocol Data Unit (PDU) session related to the S-NSSAI in a case where the PDU session is established.

### (Supplementary Note 47)

The communication apparatus according to any one of supplementary notes 43 to 46, further comprising:
means for storing the S-NSSAI in the Allowed NSSAI after performing the NSSAA procedure for the S-NSSAI.

### (Supplementary Note 48)

The communication apparatus according to any one of supplementary notes 43 to 47, further comprising:
means for sending the Allowed NSSAI in a case where the NSSAA procedure completes successfully.

### (Supplementary Note 49)

The communication apparatus according to any one of supplementary notes 43 to 48, further comprising:
means for sending Rejected NSSAI including the S-NSSAI in a case where the NSSAA procedure fails; and
means for storing the Rejected NSSAI.

### (Supplementary Note 50)

The communication apparatus according to any one of supplementary notes 43 to 49,
wherein the communication apparatus is an Access and Mobility Management Function (AMF) apparatus.

### (Supplementary Note 51)

A communication apparatus comprising:
means for receiving Allowed Network Slice Selection Assistance Information (NSSAI) including Single Network Slice Selection Assistance Information (S-NSSAI);
means for sending a message including the S-NSSAI;
means for receiving a cause value,
wherein the cause value indicates that status indicating that the S-NSSAI is not subject to Network Slice-Specific Authentication and Authorization (NSSAA) procedure is changed to status indicating that the S-NSSAI is subject to the NSSAA procedure; and
means for suspending a process related to the S-NSSAI.

### (Supplementary Note 52)

The communication apparatus according to supplementary note 51, further comprising:
means for updating the Allowed NSSAI in a case where the NSSAA procedure for the S-NSSAI is ongoing.

### (Supplementary Note 53)

The communication apparatus according to supplementary note 52, further comprising:
means for removing the S-NSSAI from the Allowed NSSAI; and
means for storing the S-NSSAI in Pending NSSAI.

### (Supplementary Note 54)

The communication apparatus according to supplementary note 51, further comprising:
means for determining whether the S-NSSAI has been authenticated and authorized successfully in a case where the NSSAA procedure for the S-NSSAI is ongoing;
means for keeping the S-NSSAI in the Allowed NSSAI in a case of determining that the S-NSSAI has been authenticated and authorized successfully; and
means for removing the S-NSSAI from the Allowed NSSAI and storing the S-NSSAI in Pending NSSAI in a case of determining that the S-NSSAI has not been authenticated and authorized successfully.

### (Supplementary Note 55)

The communication apparatus according to supplementary note 51, further comprising:
means for determining whether the NSSAA procedure for the S-NSSAI is for first time in a case where the NSSAA procedure for the S-NSSAI is ongoing;
means for keeping the S-NSSAI in the Allowed NSSAI in a case of determining that the NSSAA procedure for the S-NSSAI is for first time; and
means for removing the S-NSSAI from the Allowed NSSAI and storing the S-NSSAI in Pending NSSAI in a case of determining that the NSSAA procedure for the S-NSSAI is not for first time.

### (Supplementary Note 56)

The communication apparatus according to any one of supplementary notes 51 to 55, further comprising:
means for performing procedure for releasing a Protocol Data Unit (PDU) session related to the S-NSSAI in a case where the NSSAA procedure for the S-NSSAI is ongoing.

### (Supplementary Note 57)

The communication apparatus according to any one of supplementary notes 51 to 56, further comprising:
means for suspending process related to the S-NSSAI in a case where the NSSAA procedure for the S-NSSAI is ongoing.

### (Supplementary Note 58)

The communication apparatus according to any one of supplementary notes 51 to 57, further comprising:
means for receiving the Allowed NSSAI in a case where the NSSAA procedure completes successfully.

### (Supplementary Note 59)

The communication apparatus according to any one of supplementary notes 51 to 58, further comprising:
means for receiving Rejected NSSAI in a case where the NSSAA procedure fails; and
means for storing the Rejected NSSAI.

### (Supplementary Note 60)

The communication apparatus according to any one of supplementary notes 51 to 59,
wherein the communication apparatus is a User Equipment.

This application is based upon and claims the benefit of priority from India Patent application Ser. No. 20/221,1033469, filed on Jun. 10, 2022, the disclosure of which is incorporated herein in its entirety by reference.

### REFERENCE SIGNS LIST

3 USER EQUIPMENT
20 DATA NETWORK
201 AF
31 TRANSCEIVER CIRCUIT
32 ANTENNA
33 CONTROLLER
34 USER INTERFACE
35 USIM
36 MEMORY
361 OPERATING SYSTEM
362 COMMUNICATIONS CONTROL MODULE
3621 TRANSCEIVER CONTROL MODULE
5 (R)AN NODE
51 TRANSCEIVER CIRCUIT
52 ANTENNA
53 NETWORK INTERFACE
54 CONTROLLER
55 MEMORY
551 OPERATING SYSTEM
552 COMMUNICATIONS CONTROL MODULE
5521 TRANSCEIVER CONTROL MODULE
60 RU
601 TRANSCEIVER CIRCUIT
602 ANTENNA
603 NETWORK INTERFACE
604 CONTROLLER
605 MEMORY
6051 OPERATING SYSTEM
6052 COMMUNICATIONS CONTROL MODULE
60521 TRANSCEIVER CONTROL MODULE
61 DU
611 TRANSCEIVER CIRCUIT
612 NETWORK INTERFACE
613 CONTROLLER
614 MEMORY
6141 OPERATING SYSTEM
6142 COMMUNICATIONS CONTROL MODULE
61421 TRANSCEIVER CONTROL MODULE
62 CU
621 TRANSCEIVER CIRCUIT
622 NETWORK INTERFACE
623 CONTROLLER
624 MEMORY
6241 OPERATING SYSTEM
6242 COMMUNICATIONS CONTROL MODULE
62421 TRANSCEIVER CONTROL MODULE
7 CORE NETWORK
70 AMF
701 TRANSCEIVER CIRCUIT
702 NETWORK INTERFACE
703 CONTROLLER
704 MEMORY
7041 OPERATING SYSTEM
7042 COMMUNICATIONS CONTROL MODULE
70421 TRANSCEIVER CONTROL MODULE
71 SMF
72 UPF
73 PCF
731 TRANSCEIVER CIRCUIT
732 NETWORK INTERFACE
733 CONTROLLER
734 MEMORY
7341 OPERATING SYSTEM
7342 COMMUNICATIONS CONTROL MODULE
73421 TRANSCEIVER CONTROL MODULE
74 AUSF
741 TRANSCEIVER CIRCUIT
742 NETWORK INTERFACE
743 CONTROLLER
744 MEMORY
7441 OPERATING SYSTEM
7442 COMMUNICATIONS CONTROL MODULE
74421 TRANSCEIVER CONTROL MODULE
75 UDM
751 TRANSCEIVER CIRCUIT
752 NETWORK INTERFACE
753 CONTROLLER
754 MEMORY
7541 OPERATING SYSTEM
7542 COMMUNICATIONS CONTROL MODULE
75421 TRANSCEIVER CONTROL MODULE
76 NSSF
761 TRANSCEIVER CIRCUIT
762 NETWORK INTERFACE
763 CONTROLLER
764 MEMORY
7641 OPERATING SYSTEM
7642 COMMUNICATIONS CONTROL MODULE
76421 TRANSCEIVER CONTROL MODULE

What is claimed is:

1-8. (canceled)

61. A method of a communication apparatus, the method comprising:
receiving Allowed Network Slice Selection Assistance Information (NSSAI) including Single Network Slice Selection Assistance Information (S-NSSAI);
sending a message including the S-NSSAI;
receiving a cause value,
wherein the cause value indicates that status indicating that the S-NSSAI is not subject to Network Slice-Specific Authentication and Authorization (NSSAA) procedure is changed to status indicating that the S-NSSAI is subject to the NSSAA procedure; and
suspending a process related to the S-NSSAI.

62. The method according to claim 61, further comprising:
updating the Allowed NSSAI in a case where the NSSAA procedure for the S-NSSAI is ongoing.

63. The method according to claim 62,
wherein the updating the Allowed NSSAI includes removing the S-NSSAI from the Allowed NSSAI and storing the S-NSSAI in Pending NSSAI.

64. The method according to claim 61, further comprising:
determining whether the S-NSSAI has been authenticated and authorized successfully in a case where the NSSAA procedure for the S-NSSAI is ongoing;
keeping the S-NSSAI in the Allowed NSSAI in a case of determining that the S-NSSAI has been authenticated and authorized successfully; and
removing the S-NSSAI from the Allowed NSSAI and storing the S-NSSAI in Pending NSSAI in a case of determining that the S-NSSAI has not been authenticated and authorized successfully.

65. The method according to claim 61, further comprising:
determining whether the NSSAA procedure for the S-NSSAI is for first time in a case where the NSSAA procedure for the S-NSSAI is ongoing;
keeping the S-NSSAI in the Allowed NSSAI in a case of determining that the NSSAA procedure for the S-NSSAI is for first time; and
removing the S-NSSAI from the Allowed NSSAI and storing the S-NSSAI in Pending NSSAI in a case of determining that the NSSAA procedure for the S-NSSAI is not for first time.

66. The method according to claim 61, further comprising:
performing procedure for releasing a Protocol Data Unit (PDU) session related to the S-NSSAI in a case where the NSSAA procedure for the S-NSSAI is ongoing.

67. The method according to claim 61, further comprising:
suspending process related to the S-NSSAI in a case where the NSSAA procedure for the S-NSSAI is ongoing.

68. The method according to claim 61, further comprising:
receiving the Allowed NSSAI in a case where the NSSAA procedure completes successfully.

69. The method according to claim 61, further comprising:
receiving Rejected NSSAI in a case where the NSSAA procedure fails; and
storing the Rejected NSSAI.

70. The method according to claim 61,
wherein the communication apparatus is a User Equipment.

71. A method of a communication apparatus, the method comprising:
changing status of Single Network Slice Selection Assistance Information (S-NSSAI) included in Allowed Network Slice Selection Assistance Information (NSSAI);
performing Network Slice-Specific Authentication and Authorization (NSSAA) procedure for the S-NSSAI in a case of changing the status;
receiving a message related to the S-NSSAI; and
sending a cause value,
wherein the cause value indicates that the S-NSSAI is in Pending NSSAI.

72. The method according to claim 71,
wherein the status indicates whether the S-NSSAI is subject to the NSSAA procedure,
wherein the changing the status includes changing from the S-NSSAI which is not subject to the NSSAA procedure to the S-NSSAI which is subject to the NSSAA procedure, and
wherein the performing the NSSAA procedure includes performing the NSSAA procedure in a case of changing from the S-NSSAI which is not subject to the NSSAA procedure to the S-NSSAI which is subject to the NSSAA procedure.

73. The method according to claim 71, further comprising:
receiving information indicating that the status is changed; and
determining that the status is changed based on the information.

74. The method according to claim 71, further comprising:
performing procedure for releasing a Protocol Data Unit (PDU) session related to the S-NSSAI in a case where the PDU session is established.

75. The method according to claim 71, further comprising:
storing the S-NSSAI in the Allowed NSSAI after performing the NSSAA procedure for the S-NSSAI.

76. The method according to claim 71, further comprising:
sending the Allowed NSSAI in a case where the NSSAA procedure completes successfully.

77. The method according to claim 71, further comprising:
sending Rejected NSSAI including the S-NSSAI in a case where the NSSAA procedure fails; and
storing the Rejected NSSAI.

78. The method according to claim 71,
wherein the communication apparatus is an Access and Mobility Management Function (AMF) apparatus.

79. A communication apparatus comprising:
at least one memory storing instructions; and
at least one hardware processor coupled to the at least one memory,
wherein the at least one hardware processor is configured to execute the instructions to;
receive Allowed Network Slice Selection Assistance Information (NSSAI) including Single Network Slice Selection Assistance Information (S-NSSAI);
send a message including the S-NSSAI;
receive a cause value,
wherein the cause value indicates that status indicating that the S-NSSAI is not subject to Network Slice-Specific Authentication and Authorization (NSSAA) procedure is changed to status indicating that the S-NSSAI is subject to the NSSAA procedure; and
suspend a process related to the S-NSSAI.
